(19) United States
(12) Patent Application Publication
(10) Pub. No.: US 2024/0059891 A1
(43) Pub. Date: Feb. 22, 2024

(54) Composition Comprising Silyl-Modified Prepolymer and Highly Structured Carbon Black

(71) Applicant: Zephyros, Inc., Romeo, MI (US)

(72) Inventors: Dietmar Golombowski, Molsheim Cedex (FR); George Anthony Buchan, Northamptonshire (GB); Alessandro Galbiati, Gambolo (IT)

(21) Appl. No.: 18/265,822

(22) PCT Filed: Dec. 8, 2021
(86) PCT No.: PCT/EP2021/084695

§ 371 Date: Jun. 7, 2023

(30) Foreign Application Priority Data
Dec. 8, 2020 (EP) 20212438.4

(51) Int. Cl. C08L 71/00; C08K 3/04; C08K 3/36

(52) U.S. Cl. CPC C08L 71/00; C08K 3/04; C08K 3/36

(57) ABSTRACT

The invention relates to a curable one-component composition comprising (i) humidity-curable prepolymer, preferably silyl-modified prepolymer; (ii) optionally, highly structured carbon black; (iii) optionally, fumed silica; (iv) optionally, polycarbonate, preferably polycarbonate diol; (v) optionally, plasticizer, preferably SAN-grafted polyol; (vi) optionally, silane compatibilizer; and (vii) optionally, curing catalyst, with the proviso that the composition comprises (ii), or (iii), or both (ii) and (iii). The composition is useful inter alia for bonding glass into vehicles and buildings.

Priority is claimed of European patent application no. 20 212 438.4 that was filed on Dec. 8, 2020.

The invention relates to a curable one-component composition comprising (i) humidity-curable prepolymer, preferably silyl-modified prepolymer; (ii) optionally, highly structured carbon black; (iii) optionally, fumed silica; (iv) optionally, polycarbonate, preferably polycarbonate diol; (v) optionally, plasticizer, preferably SAN-grafted polyol; (vi) optionally, silane compatibilizer; and (vii) optionally, curing catalyst, with the proviso that the composition comprises (ii), or (iii), or both (ii) and (iii). The composition is useful inter alia for bonding glass into vehicles and buildings

Adhesive or sealant compositions are used for fenestration, i.e. to affix windows into buildings and vehicles. In this regard, reference is made to e.g. U.S. Pat. Nos. 4,780,520, 5,976,305, 5,922,809, 6,015,475, 6,709,539, 7,226,523, 6,512, 7,101,950, 7,361,292, 6,657,035, CA 2,564,992, and WO 2010 074768A1.

Nowadays, adhesive or sealant compositions need to satisfy certain performance properties such as high strength paired with high elongation, but also durable adhesion under various climate conditions. Climate cycle tests have been developed by original equipment manufacturers (OEM) involving sample testing under harsh conditions such as 70° C. cataplasm with freezing step. Modern adhesive or sealant compositions need to pass such tests.

Conventional adhesive or sealant compositions are often based upon polyurethanes containing reactive isocyanate groups such as toluene diisocyanate (TDI), methylene bisphenyl diisocyanate (MDI), hexamethylene diisocyanate (HDI), naphthalene diisocyanate (NDI), and diisocyanate dicyclohexyl urethane. Such isocyanate products are hazardous as they are powerful irritants to the mucous membranes of the eyes, gastrointestinal and respiratory tracts. Health effects of isocyanate exposure include irritation of skin and mucous membranes, chest tightness, and difficult breathing. Isocyanates include compounds classified as potential human carcinogens and known to cause cancer in animals. The main effects of hazardous exposures are occupational asthma and other lung problems, as well as irritation of the eyes, nose, throat, and skin.

Further, conventional adhesive or sealant compositions often contain phthalates as plasticizers. Phthalate plasticizers are not chemically bound in the cured adhesive compositions, but can leach, migrate or evaporate into indoor air. Building materials such as vinyl flooring and other consumer products containing phthalates can result in human exposure through direct contact and use, indirectly through leaching into other products, or general environmental contamination. Humans are exposed through ingestion, inhalation, and dermal exposure during their whole lifetime. Many phthalates are hormone-disrupting chemicals that interfere with the production of testosterone. Prenatal exposure to certain phthalates causes common adverse effects on male reproductive development in animals, causing what is known as “phthalate syndrome”, which has many similarities to “testicular dysgenesis syndrome” in humans.

US 2019 0048190 A1 relates to moisture curing alkoxysilyl-functional polymer compositions containing a high phenyl-content silicone resin and carbon black.

WO 2017 189057 A1 relates to moisture-curable, one component adhesives contain an isocyanate-terminated prepolymer, a low molecular weight polyisocyanate compound, a hydrolysable mercaptosilane, a urethane catalyst and a carbon black filler.

WO 2014 073593 A1 relates to a curable composition which contains (A) a branched polyoxyalkylene polymer having a reactive silicon group, (C) calcium carbonate and (D) carbon black.

US 2018 0134932 A1 relates to an one part moisture curable composition comprised of an isocyanate functional prepolymer, a cyclic silane, a filler and a catalyst.

WO 2017 142714 A1 relates to compositions containing isocyanate functional prepolymers, quaternary ammonium modified nanoclays and thixotropic fillers; adhesives based on such compositions; and methods for bonding substrates together utilizing the compositions.

US 2019 0233335 A1 relates to a porous inorganic additive manufactured article that is comprised of at least two layers of inorganic particulates bound together by a carbon binding phase throughout.

There is thus a demand for adhesive or sealant compositions that neither contain isocyanates nor phthalates. While certain adhesive compositions based upon silicone polymers, e.g. polysiloxanes, are also well known sealants, durable elastic adhesive compositions that achieve equal performance like compositions based upon polyurethane prepolymers have not been available for decades.

Still further, conventional adhesive or sealant compositions often rely upon dual-curing systems and thus require post-curing in an oven. It would be desirable, however, to provide adhesive or sealant compositions that completely cure at the initial curing step such that upon subsequent storage for 42 days (1000 hours) at 80° C. no post-curing can be observed and original strength is retained.

Furthermore, conventional adhesive or sealant compositions often require a pretreatment of substrate surfaces before the compositions may be applied thereto in order to provide satisfactory bonding. Such pretreatment, however, is time-consuming and laborious and there is a demand for adhesive or sealant compositions that do not require such pretreatment but nonetheless provide excellent adherence to surfaces of various materials including glass, plastics and metals.

Moreover, after a certain while of use or e.g. after an accident, the adhesive bonds or sealings need to be repaired are renewed. However, conventional adhesive or sealant compositions are often difficult the be removed or repaired, especially when they are bonded to polyurethane substrates. It would thus be desirable to provide adhesive or sealant compositions that facilitate renewal and repair.

What is thus needed are adhesive or sealant compositions that are useful for bonding glass and other substrates into a structure which may be formulated to exhibit a variety of high performance properties such as durable adhesion satisfying climate cycle testing including 70° C. cataplasm with freezing step, high strength paired with high elongation, and that show no post-cure after storage for 42 days at 80° C. Further, there is a need for adhesive or sealant compositions that are ready to use and do not require pretreatment of substrate surfaces such as glass surfaces, and that provide repairability on polyurethane substrates.

It is an object of the invention to provide adhesive or sealant compositions that overcome the drawbacks of the prior art and that satisfy one or more of the above needs.

This object has been achieved by the subject-matter of the patent claims.

It has been surprisingly found that humidity-curable prepolymers, preferably silyl-modified prepolymers, in combination with highly structured carbon black provide advantageous adhesive or sealant compositions. The use of silyl-modified prepolymers, preferably in combination with silane compatibilizers, achieves robust primerless adhesion to glass surfaces, i.e. does not require pretreatment. Various silyl-modified prepolymers such as polyols are commercially available and have well defined molecular weight distribution and polymer polarity. It has been found that the properties of the one-component curable compositions according to the invention can be tailored to the specific needs by selecting the proper silyl-modified polymers, preferably polyols, or combinations thereof.

Further, it has been surprisingly found that compared to other types of carbon black, the use of highly structured carbon black according to the invention also contributes to primerless adhesion to glass substrates and other substrates, and additionally provides high strength at high elongation as well as excellent climate durability.

Still further, it has been surprisingly found that the combination of silyl-modified polymers with highly structured carbon black achieves reduced post-cure effects at elevated temperatures (e.g. at 100° C.). Thus, increased brittleness upon storage at elevated temperatures, which is typically observed with polyurethanes, can be suppressed with the compositions according to the invention.

Yet further, it has been surprisingly found that polycarbonate diols, i.e. polycarbonates having terminal hydroxyl groups, provide a quick fixation after heating and recrystallizing as they can be liquids and crystalline solids. Further, it has been surprisingly found that utilization of polycarbonates having various melting points allows for adjusting rheology like shear thinning, sag resistance, recovery and tailing for improved application properties in mass application environment requiring short handling times. It has been surprisingly found that polycarbonates, especially polycarbonate diols, further enhance multi-substrate adhesion, durability and high strength performance.

Furthermore, it has been surprisingly found that fumed silica, especially certain grades of fumed silica, have a positive effect on multi-substrate adhesion including glass, durability and high strength.

A first aspect of the invention relates to a curable one-component composition comprising the following components:
(i) humidity-curable prepolymer, preferably silyl-modified prepolymer, more preferably silyl-modified polyether prepolymer;
(ii) optionally, highly structured carbon black, preferably having a iodine number≥95 g/kg, and an oil absorption number (OAN)≥115 ml/100 g;
(iii) optionally, fumed silica, preferably organically modified fumed silica; more preferably hydrophobic fumed silica; still more preferably treated with polydimethylsiloxane;
(iv) optionally, polycarbonate, preferably polycarbonate diol;
(v) optionally, plasticizer; preferably selected from the group consisting of polyol, SAN-grafted polyol, 1,2-cyclohexane dicarboxylic acid esters, phthalates, and mixtures thereof; more preferably selected from the group consisting of polyol, SAN-grafted polyol, 1,2-cyclohexane dicarboxylic acid esters, and mixtures thereof;
(vi) optionally, silane compatibilizer; and
(vii) optionally, curing catalyst;
   with the proviso that the composition comprises (ii), or (iii), or both (ii) and (iii).

Another aspect of the invention relates to a curable one-component composition comprising the following components:
(i) humidity-curable prepolymer, preferably silyl-modified prepolymer, more preferably silyl-modified polyether prepolymer;
(ii) highly structured carbon black, preferably having a iodine number≥95 g/kg, and an oil absorption number (OAN)≥115 ml/100 g;
(iii) optionally, fumed silica, preferably organically modified fumed silica; more preferably hydrophobic fumed silica; still more preferably treated with polydimethylsiloxane;
(iv) optionally, polycarbonate, preferably polycarbonate diol;
(v) optionally, plasticizer; preferably selected from the group consisting of polyol, SAN-grafted polyol, 1,2-cyclohexane dicarboxylic acid esters, phthalates, and mixtures thereof; more preferably selected from the group consisting of polyol, SAN-grafted polyol, 1,2-cyclohexane dicarboxylic acid esters, and mixtures thereof;
(vi) optionally, silane compatibilizer; and
(vii) optionally, curing catalyst.

Another aspect of the invention relates to a curable one-component composition comprising the following components:
(i) humidity-curable prepolymer, preferably silyl-modified prepolymer, more preferably silyl-modified polyether prepolymer;
(ii) optionally, carbon black (which does not necessarily need to be highly structured), preferably highly structured carbon black, more preferably having a iodine number≥95 g/kg, and an oil absorption number (OAN)≥115 ml/100 g;
(iii) fumed silica, preferably organically modified fumed silica; more preferably hydrophobic fumed silica; still more preferably treated with polydimethylsiloxane;
(iv) optionally, polycarbonate, preferably polycarbonate diol;
(v) optionally, plasticizer; preferably selected from the group consisting of polyol, SAN-grafted polyol, 1,2-cyclohexane dicarboxylic acid esters, phthalates, and mixtures thereof; more preferably selected from the group consisting of polyol, SAN-grafted polyol, 1,2-cyclohexane dicarboxylic acid esters, and mixtures thereof;
(vi) optionally, silane compatibilizer; and
(vii) optionally, curing catalyst.

Preferably, the curable one-component composition according to the invention contains highly structured carbon black and/or organically modified fumed silica.

In preferred embodiments, the curable one-component composition according to the invention contains highly structured carbon black. The term “highly structured carbon black” also referred to as HSCB is a terminus technicus well known to the skilled person. The property of this type of carbon black being highly structured is reflected in its capability of absorbing oil. For the purpose of the specification, any carbon black having an oil absorption number (OAN, ASTM D 2414) of at least 115 ml/100 g is to be regarded as highly structured carbon black according to the invention.

For the purpose of the specification, unless expressly stated otherwise, percentages are percent by weight. Unless expressly stated otherwise, any norms such as EN ISO, ASTM and the like are in the official version that is valid on Dec. 1, 2020. The expression “essentially consists of” means a content of at least 95 wt.-%, preferably at least 99 wt.-%, relative to the total weight of the component to which the definition refers.

The composition according to the invention is a one-component composition. Thus, the composition according to the invention is preferably a ready-to use composition that already contains all ingredients that are needed for the desired purpose, except air humidity. In particular, prior to use, the composition according to the invention does preferably not require any addition of further additives nor admixture with other compositions.

The composition according to the invention is curable, i.e. is capable of autonomously undergoing a curing reaction, typically by cross-linking, after proper stimulation, preferably by subjecting the composition to humidity. Typically, the humidity that is contained in the atmosphere is sufficient in order to stimulate, i.e. induce the curing reaction to a partial or full extent. Partial curing or curing (i.e. full curing) may be effected by reacting one or more ingredients that are contained in the composition with one another thereby forming covalent bonds.

Components (iv), (v), (vi) and (vii) of the composition according to the invention are independently of one another optional, whereas component (i) and components (ii) and/or (iii) are mandatory. In preferred embodiments, the composition comprises components (i) and (ii) but not (iii). In other preferred embodiments, the composition comprises components (i) and (iii) but not (ii). In further preferred embodiments, the composition comprises components (i), (ii), and (iii). Besides components (i) through (vii), the composition according to the invention may contain additional ingredients.

In preferred embodiments, the composition according to the invention is an adhesive.

In preferred embodiments, the composition according to the invention is a sealant.

In preferred embodiments, the composition according to the invention is capable of curing spontaneously at 23° C. upon contact with air humidity.

The curable one-component composition according to the invention comprises a humidity-curable prepolymer. The curable one-component composition according to the invention may comprise a single humidity-curable prepolymer or a mixture of two or more humidity-curable prepolymers. In case of the presence of two or more humidity-curable prepolymers, all weights and percentages refer to the total weight of all humidity-curable prepolymers that are contained in the curable one-component composition.

Preferably, the humidity-curable prepolymer comprises or essentially consist of a silyl-modified prepolymer.

For the purpose of the specification, a prepolymer (polymer precursor) is a monomer or system of monomers that have been reacted to an intermediate molecular mass state. This material is capable of further polymerization by reactive groups to a fully cured high molecular weight state. Prepolymers encompass mixtures of reactive polymers with unreacted monomers. The prepolymer is humidity-curable, i.e. upon contact with humidity undergoes spontaneous curing, optionally also involving other ingredients that are contained in the composition such as curing agents.

Humidity-curable prepolymers are known to the skilled person and commercially available.

In preferred embodiments of the curable composition according to the invention, the humiditycurable prepolymer is a silyl-modified prepolymer. As the preferred silyl-modified polymer is a curable prepolymer, it is a reactive prepolymer (reactive silyl-modified prepolymer). Silyl-modified prepolymers (SMP, silane-modified polymers, modified-silane polymers, MS polymers, silane-terminated polymers, etc.) are known to the skilled person and commercially available. For details on silyl-modified prepolymers, it can be referred to e.g. S. M. Guillaume, Advances in the synthesis of silyl-modified polymers (SMPs), Polym. Chem., 2018, 9, 1911-1926; A. Pizzi et al., Handbook of Adhesive Technology, CRC Press, 3rd edition, 2018. Examples of silyl-modified polymers include but are not limited to silyl-modified polyethers and copolyethers, silyl modified polyisobutylenes (SMPIB), silyl-modified polyacrylates and copolyacrylates (SMA) and silyl-modified polyurethanes (SPUR, PUH).

Preferably the silyl-modified prepolymer has a non-silicone backbone, more preferably this silyl-modified prepolymer has a polyether backbone. For example, the silyl modified prepolymer can be dimethoxysilane modified polymer, trimethoxysilane modified polymer, or triethoxysilane modified polymer. For example, the silyl modified prepolymer can be a silyl-modified polyether or copolyether.

Preferred silyl-modified prepolymers according to the invention are selected from
(i) silyl-modified polyethers or copolyethers, preferably silyl-terminated polyethers or copolyethers, e.g. silyl-modified polyethylene glycols, silyl-modified polypropylene glycols, and the like;
(ii) silyl-modified polyurethanes, preferably silyl-terminated polyurethanes; and
(iii) silyl-modified acrylates, preferably silyl-terminated acrylates.

In other preferred embodiments, the silyl-modified prepolymers according to the invention do not comprise ethylenically unsaturated functional groups.

Preferably, the silyl-modified prepolymer comprises a polymeric backbone and one or more hydrolyzable silyl groups.

Preferably, the silyl-modified prepolymer has two ends and is terminated with one or more hydrolyzable silyl groups on one end (semi-telechelic) or on both ends (telechelic); preferably on two ends.

Preferably, the silyl-modified prepolymer has side chains carrying one or more hydrolyzable silyl groups.

Preferably, hydrolysis of at least one of the one or more hydrolyzable silyl groups leads to the formation of a silanol group.

Preferably, the condensation of the silanol group with another silanol group or with a hydrolyzable silyl group leads to the formation of a siloxane group.

In preferred embodiments, the one or more hydrolyzable silyl groups independently of one another are
monopodal silyl groups of general formula (I)

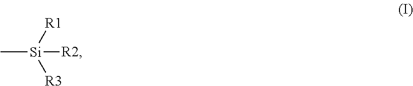

or
dipodal silyl groups of general formula (II)

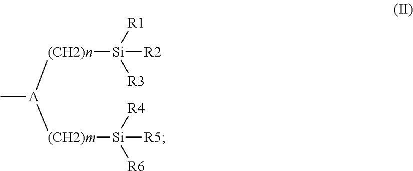

wherein in each case R1, R2, R3, R4, R5 and R6 independently of one another are selected from
substituents forming silicon-carbon bonds selected from the group consisting of -C₁₋₁₂-alkyl, -C₁₋₆-alkylene-O-C₁₋₆-alkyl, -C₆₋₁₀-aryl, -C₁₋₆-alkylene-C₆₋₁₀-aryl, -C₁₋₆-alkylene-O-C₆₋₁₀-aryl;
substituents forming silicon-oxygen bonds selected from the group consisting of —O—C₁₋₁₂-alkyl, —O—C₁₋₆-alkylene-O—C₁₋₆-alkyl, —O—C₆₋₁₀-aryl, —O—C₁₋₆-alkylene-C₆₋₁₀-aryl, —OC(═O)-C₁₋₁₂-alkyl, —OC(═O)-C₁₋₆-alkylene-O—C₁₋₆-alkyl, —OC(═O)-C₆₋₁₀-aryl, —OC(═O)-C₁₋₆-alkylene-C₆₋₁₀-aryl, —OC(═O)-C₁₋₆-alkylene-O—C₆₋₁₀-aryl;
substituents forming silicon-nitrogen bonds selected from the group consisting of —NH—C₁₋₁₂-alkyl, —NH—C₁₋₆-alkylene-O—C₁₋₆-alkyl, —NH—C₆₋₁₀-aryl, —NH—C₁₋₆-alkylene-C₆₋₁₀-aryl, —NH—C₁₋₆-alkylene-O—C₆₋₁₀-aryl;
substituents forming silicon-halogen bonds selected from the group consisting of -F, -Cl, -Br, -I;
   with the proviso that at least one of R1, R2 and R3, and at least one of R4, R5 and R6 is not a substituent forming silicon-carbon bonds; preferably with the proviso that at least one of R1, R2 and R3, and at least one of R4, R5 and R6 is selected from substituents forming silicon-oxygen bonds;
A represents —N< or —CH<; and
m and n independently of one another are an integer within the range of from 0 to 18, preferably 1, 2, 3 or 4.

In preferred embodiments, R1, R2, R3, R4, R5 and R6 independently of one another represent —CH₃, —CH₂CH₃, —CH₂CH₂CH₃, —CH(CH₃)₂, —CH₂CH₂CH₂CH₃, —CH(CH₃)CH₂CH₃, —CH₂CH(CH₃)2, —C(CH₃)₃, —CH₂CH₂OCH₃, —CH₂CH₂OCH₂CH₃, —CH₂CH₂CH₂OCH₃, —CH₂CH₂CH₂OCH₂CH₃, —OCH₃, —OCH₂CH₃, —OCH₂CH₂CH₃, —OCH(CH₃)2, —OCH₂CH₂CH₂CH₃, —OCH(CH₃)CH₂CH₃, —OCH₂CH(CH₃)₂, —OC(CH₃)₃, —OCH₂CH₂OCH₃, —OCH₂CH₂OCH₂CH₃, —OCH₂CH₂CH₂OCH₃, or —OCH₂CH₂CH₂OCH₂CH₃.

Preferably, the one or more hydrolyzable silyl groups independently of one another are selected from the group consisting of monomethoxy silyl groups, monoethoxy silyl groups, dimethoxy silyl groups, diethoxy silyl groups, trimethoxy silyl groups, and triethoxy silyl groups.

Preferably, the one or more hydrolyzable silyl groups are covalently bonded to the polymeric backbone through spacers, wherein the spacers independently of one another are selected from -C₁₋₁₂alkylene-, -C₃₋₈-cycloalkylene-, -phenyl-, -C₁₋₆-alkylene-phenyl-, -C₁₋₆-alkylene-phenyl-C₁₋₆-alkylene-, —C(═O)C₁₋₆-alkylene-, —S(═O)₂C₁₋₆-alkylene-, —NHC(═O)—C₁₋₆-alkylene-, —C(═O)NHC₁₋₆-alkylene-, —NHS(═O)₂-C₁₋₆-alkylene-, —S(═O)₂NHC₁₋₆-alkylene-, —OC(═O)—C₁₋₆-alkylene-, —C(═O)OC₁₋₆-alkylene-, —OS(═O)₂-C₁₋₆-alkylene-, —S(═O)₂OC₁₋₆-alkylene-, —OC(═O)NH—C₁₋₆-alkylene-, —NHC(═O)O—C₁₋₆-alkylene-, —OC(═O)O—C₁₋₆-alkylene-, —NHC(═O)NH—C₁₋₆-alkylene-, —O—[Si(CH₃)₂—O]₁₋₁₂-, azasilanes, and combinations thereof.

In preferred embodiments, the silyl-modified prepolymer is
an alpha silyl prepolymer; preferably wherein the one or more hydrolyzable silyl groups are covalently bonded to the polymeric backbone through spacers, independently of one another selected from —CH₂—, —NH—CH₂—, —NHC(═O)—CH₂—, —C(═O)NH—CH₂—, —O—CH₂—, —OC(═O)—CH₂—, —C(═O)O—CH₂—, —OC(═O)NH—CH₂—, —NHC(═O)O—CH₂—, —OC(═O)O—CH₂—, and —NHC(═O)NH—CH₂—;
a beta silyl prepolymer; preferably wherein the one or more hydrolyzable silyl groups are covalently bonded to the polymeric backbone through spacers, independently of one another selected from CH₂CH₂—, —NH—CH₂CH₂—, —NHC(═O)—CH₂CH₂—, —C(═O)NH—CH₂CH₂—, —O—CH₂CH₂—, —OC(═O)—CH₂CH₂—, —C(═O)O—CH₂CH₂—, —OC(═O)NH—CH₂CH₂—, —NHC(═O)O—CH₂CH₂—, —OC(═O)O—CH₂CH₂—, and —NHC(═O)NH—CH₂CH₂—;
a gamma silyl prepolymer; preferably wherein the one or more hydrolyzable silyl groups are covalently bonded to the polymeric backbone through spacers, independently of one another selected from —CH₂CH₂CH₂—, —NH—CH₂CH₂CH₂—, —NHC(═O)—CH₂CH₂CH₂—, —C(═O)NH—CH₂CH₂CH₂—, CH₂CH₂CH₂—, —OC(═O)—CH₂CH₂CH₂—, —C(═O)O—CH₂CH₂CH₂—, —OC(═O)NH—CH₂CH₂CH₂—, —NHC(═O)O—CH₂CH₂CH₂—, —OC(═O)O—CH₂CH₂CH₂—, and —NHC(═O)NH—CH₂CH₂CH₂—; or
a delta silyl prepolymer; preferably wherein the one or more hydrolyzable silyl groups are covalently bonded to the polymeric backbone through spacers, independently of one another selected from —CH₂CH₂CH₂CH₂—, —NH—CH 2 CH 2 CH 2 CH 2 —, —NHC(═O) —CH₂CH₂CH₂CH₂—, —C(═O)NH—CH₂CH₂CH₂CH₂—, —O—CH₂CH₂CH₂CH₂—, —OC(═O)—CH₂CH₂CH₂CH₂—, —C(═O)O—CH₂CH₂CH₂CH₂—, —OC(═O)NH—CH₂CH₂CH₂CH₂—, —NHC(═O)O—CH₂CH₂CH₂CH₂—, —OC(═O)O—CH₂CH₂CH₂CH₂—, and —NHC(═O)NH—CH₂CH₂CH₂CH₂—.

Preferably, the humidity-curable prepolymer comprises a polymeric backbone selected from the group consisting of polyethers, copolyethers, polyurethanes, copolyurethanes, polyesters, copolyesters, polyamides, copolyamids, polyolefins, copolyolefins, polystyrenes, copolystyrenes, polyacrylates, copolyacrylates, and mixtures thereof; preferably polyethers or copolyethers.

In preferred embodiments, the polymeric backbone is a linear or branched, aliphatic and/or aromatic polyether comprising ether repetition units.

In preferred embodiments, the polymeric backbone is a linear or branched, aliphatic and/or aromatic copolyether comprising ether repetition units and comonomer repetition units; preferably wherein the comonomer repetition units are selected from urethane repetition units, ester repetition units, amide repetition units, carbonate repetition units, urea repetition units, alkyl repetition units, and mixtures thereof.

In preferred embodiments, the humidity-curable prepolymer is selected from the group consisting of dimethoxy-silyl-terminated polyether or copolyether, trimethoxy-silyl-terminated polyether or copolyether, dimethoxy-silyl-terminated polyether or copolyether in each case reinforced with silicone moieties, trimethoxy-silyl-terminated polyether or copolyether in each case reinforced with silicone moieties, hydrophobically modified dimethoxy-silyl-terminated polyether or copolyether, monofunctional dimethoxy-silyl-terminated polyether or copolyether, and monofunctional trimethoxy-silyl-terminated polyether or copolyether.

The silyl-modified polyether or copolyether can be obtained by reacting a polyether or copolyether with at least one ethylenically unsaturated silane in the presence of a radical starter, the ethylenically unsaturated silane carrying at least one hydrolyzable group on the silicon atom. The ethylenically unsaturated silane is particularly preferably selected from the group consisting of vinyltrimethoxysilane, vinyltriethoxysilane, vinyldimethoxymethylsilane, vinyldiethoxymethylsilane, trans-p-methylacrylic acid trimethoxysilylmethyl ester, and trans-b-methylacrylic acid trimethoxysilylpropyl ester.

Silyl-modified prepolymers such as silyl-modified polyether and copolyether are available, for example, as dimethoxysilane modified MS polymer from Kaneka, trimethoxysilane modified ST polymer from Evonik, triethoxysilane modified Tegopac polymer from Evonik, silane modified Desmoseal polymer from Covestro, or silane modified SMP polymer from Henkel.

In preferred embodiments, the humidity-curable prepolymer has a weight average molecular weight (ASTM D5296-19)
of at least about 500 g/mol, preferably at least about 100 g/mol, more preferably at least about 1500 g/mol; and/or;
of at most about 50,000 g/mol, preferably at most about 40,000 g/mol, more preferably at most about 25,000 g/mol; and/or
within the range of from about 500 to 50,000 g/mol, preferably about 1000 to 25,000 g/mol.

In preferred embodiments, the humidity-curable prepolymer has a Brookfield viscosity at 23° C. (ASTM D789, D4878)
of at least about 100 mPa·s, preferably at least about 500 mPa·s; and/or
of at most about 35,000 mPa·s; and/or
within the range of from about 100 to 35,000 mPa·s, preferably about 500 to 35,000 mPa·s.

In particularly preferred embodiments of the curable one-component composition according to the invention, the weight content of the humidity-curable prepolymer is at most 45 wt.-%.

In preferred embodiments of the curable one-component composition according to the invention, the weight content of the humidity-curable prepolymer is
at least about 10 wt.-%, preferably at least about 12 wt.-%, more preferably at least about 15 wt.-%, still more preferably at least about 18 wt.-%, yet more preferably at least about 22 wt.-%, even more preferably at least about 26 wt.-%, most preferably at least about 30 wt.-%, and in particular at least about 35 wt.-%; and/or
at most about 90 wt.-%, preferably at most about 85 wt.-%, more preferably at most about 80 wt.-%, still more preferably at most about 75 wt.-%, yet more preferably at most about 70 wt.-%, even more preferably at most about 65 wt.-%, most preferably at most about 60 wt.-%, and in particular at most about 55 wt.-%; more preferably less than 50 wt.-%; still more preferably at most 45 wt.-%; and/or
within the range of from about 10 to 90 wt.-%, preferably from about 20 to 80 wt.-%, more preferably from about 30 to 70 wt.-%, still more preferably from about 35 to 55 wt.-%;
   in each case relative to the total weight of the curable one-component composition.

The curable one-component composition according to the invention comprises highly structured carbon black. The curable one-component composition according to the invention may comprise a single kind of highly structured carbon black or a mixture of two or more kinds of highly structured carbon black. In case of the presence of two or more kinds of highly structured carbon black, all weights and percentages refer to the total weight of all kinds of highly structured carbon black that are contained in the curable one-component composition.

Highly structured carbon black (high structure carbon black) has more porous aggregates per unit weight than other kinds of carbon black. In the classification systems used to classify carbon black, highly structured carbon black is typically referred to as “HS” (high structure) as opposed to “LS” (low structure).

In a simplified manner, the carbon black particles can be described as an aggregate of a number of smaller particles, which are referred to as “primary particles.” The carbon black aggregates can be, for example, assemblies of primary carbon black particles that are fused at the contact points and cannot readily be separated by shearing. The size of primary particles in a carbon black particle can vary. The number of primary particles in the aggregate can also vary, for example, from few to tens, or possibly hundreds. The number of primary particles and the arrangement of them in the carbon black aggregate not only dictate the size of the carbon black aggregate but also the structure of the carbon black.

The ASTM D 1765 classification system uses a four-character code for the identification of carbon black grades, composed of one letter and three numbers. The letter refers to the rate of vulcanization of a rubber loaded compound with this type of carbon black; “N” means “normal rate of vulcanization”, “S” means “slow rate of vulcanization”. The first number after the letter is related to the primary particle size, whereas the other two numbers further specify surface area and structure. Representative examples of carbon blacks are classified as follows:

| | Iodine no. | CTAB | BET | OAN | 24M4-DBP | |
|---|---|---|---|---|---|---|
| Code | [g/kg] | [m²/g] | [m²/g] | [ml/100 g] | [ml/100 g] | Type |
| N110 | 145 | 126 | 143 | 112 | 98 | SAF |
| N115 | 160 | 128 | 145 | 113 | 97 | SAF-HS |
| N121 | 121 | 121 | 132 | 132 | 112 | SAF-HS |
| N220 | 121 | 111 | 119 | 114 | 100 | ISAF |
| N234 | 120 | 119 | 126 | 125 | 100 | ISAF to HS |
| N326 | 82 | 83 | 84 | 72 | 69 | HAF to LS |
| N330 | 82 | 83 | 83 | 102 | 88 | HAF |
| N339 | 90 | 95 | 96 | 120 | 101 | HAF to HS |
| N375 | 90 | 98 | 100 | 114 | 97 | HAF to HS |
| N539 | 43 | 41 | 41 | 111 | 84 | FEF |
| N550 | 43 | 42 | 42 | 121 | 88 | FEF |
| N650 | 36 | 38 | 38 | 122 | 87 | GPF to HS |
| N660 | 36 | 35 | 35 | 90 | 75 | GPF |
| N762 | 27 | 29 | 28 | 65 | 57 | SRF |
| N765 | 31 | 33 | 31 | 115 | 86 | SRF to HS |
| N774 | 29 | 29 | 29 | 72 | 62 | SRF |
| N990 | — | 9 | 9 | 43 | 40 | MT |

SAF = super abrasion resistant furnace black;
ISAF = intermediate super abrasion resistant furnace black;
HAF = hifg abrasion resistant furnace black;
FEF = fast extrusion furnace black;
GFP = general purpose furnace black;
SRF = semi reinforcing furnace black;
MT = medium thermal black;
HS = high structure;
LS = low structure

Thus, as indicated by the above table, highly structured (“HS”) carbon black is a terminus technicus well acknowledged in the art. Highly structured variants of carbon black exist for different kinds of carbon black, i.e. different primary particle sizes and different surface areas.

Preferably, the highly structured carbon black comprises or essentially consist of furnace black.

Particularly preferred highly structured carbon black has a iodine number (ASTM D1510) of at least 95 g/kg and an oil absorption number (OAN, ASTM D 2414) of at least 110 ml/100 g, preferably at least 115 ml/100 g.

Preferably, the highly structured carbon black is typified according to ASTM D 1765 as super abrasion resistant furnace black (SAF-HS), intermediate super abrasion resistant furnace black (ISAF-HS), high abrasion resistant furnace black (HAF-HS), general purpose furnace black (GPF-HS), or semi reinforcing furnace black (SRF-HS).

Preferably, the highly structured carbon black is classified according to ASTM D 1765 in a group selected from N110, N115, N120, N121, N125, N134, N135, N219, N220, N231, N234, N293, N299, N326, N330, N335, N339, N343, N347, N351, N356, N358, N375, N539, N550, N582, N630, N642, N650, N660, N683, N754, N762, N765, N772, N774, and N787; preferably N115, N121, N234, N339, N375, N539, N550, N650, and N765.

Carbon black may be classified according to iodine number, CTAB surface area and nitrogen absorption surface area which reflect different surface properties. The iodine number (iodine adsorption) reflects a “not true” surface area, because it is affected by porosity, surface impurities, and surface oxidation. The cetyltrimethyl ammonium bromide (CTAB) surface area analyzes the so-called external surface area which corresponds to the accessible surface area e.g. for an elastomer. The BET (Brunauer, Emmett, and Teller) nitrogen adsorption surface area provides the “total” surface area including porosity.

In preferred embodiments of the curable one-component composition according to the invention, the highly structured carbon black has an iodine number (ASTM D1510)
of at least about 30 g/kg, preferably at least about 40 g/kg, more preferably at least about 50 g/kg, still more preferably at least about 60 g/kg, yet more preferably at least about 70 g/kg, even more preferably at least about 80 g/kg, most preferably at least about 90 g/kg, and in particular at least about 100 g/kg; and/or
of at most about 240 g/kg, preferably at most about 230 g/kg, more preferably at most about 220 g/kg, still more preferably at most about 210 g/kg, yet more preferably at most about 200 g/kg, even more preferably at most about 190 g/kg, most preferably at most about 180 g/kg, and in particular at most about 170 g/kg; and/or
within the range of about 50±25 g/kg, or 60±25 g/kg, or 70±25 g/kg, or 80±25 g/kg, or 90±25 g/kg, or 100±25 g/kg, or 110±25 g/kg, or 120±25 g/kg, or 130±25 g/kg, or 140±25 g/kg, or 150±25 g/kg, or 160±25 g/kg, or 170±25 g/kg.

In preferred embodiments of the curable one-component composition according to the invention, the highly structured carbon black has a cetytrimethyl ammonium bromide absorption (CTAB number, statistical thickness surface area (STSA), ASTM D 3765)
of at least about 30 m²/g, preferably at least about 40 m²/g, more preferably at least about 50 m²/g, still more preferably at least about 60 m²/g, yet more preferably at least about 70 m²/g, even more preferably at least about 80 m²/g, most preferably at least about 90 m²/g, and in particular at least about 100 m²/g; and/or
of at most about 200 m²/g, preferably at most about 190 m²/g, more preferably at most about 180 m²/g, still more preferably at most about 170 m²/g, yet more preferably at most about 160 m²/g, even more preferably at most about 150 m²/g, most preferably at most about 140 m²/g, and in particular at most about 130 m²/g; and/or
within the range of about 50±25 m²/g, or 60±25 m²/g, or 70±25 m²/g, or 80±25 m²/g, or 90±25 m²/g, or 100±25 m²/g, or 110±25 m²/g, or 120±25 m²/g, or 130±25 m²/g, or 140±25 m²/g.

In preferred embodiments of the curable one-component composition according to the invention, the highly structured carbon black has a Brunauer-Emmett-Teller (BET) surface area (nitrogen absorption, nitrogen surface area (NSA), ASTM D 6556)
of at least about 50 m²/g, preferably at least about 60 m²/g, more preferably at least about 70 m²/g, still more preferably at least about 80 m²/g, yet more preferably at least about 90 m²/g, even more preferably at least about 100 m²/g, most preferably at least about 110 m²/g, and in particular at least about 120 m²/g; and/or
of at most about 220 m²/g, preferably at most about 210 m²/g, more preferably at most about 200 m²/g, still more preferably at most about 190 m²/g, yet more preferably at most about 180 m²/g, even more preferably at most about 170 m²/g, most preferably at most about 160 m²/g, and in particular at most about 150 m²/g; and/or
within the range of about 50±25 m²/g, or 60±25 m²/g, or 70±25 m²/g, or 80±25 m²/g, or 90±25 m²/g, or 100±25 m²/g, or 110±25 m²/g, or 120±25 m²/g, or 130±25 m²/g, or 140±25 m²/g, or 150±25 m²/g, or 160±25 m²/g; preferably within the range of from about 17 to 33 m²/g, or about 26 to 42 m²/g, or about 36 to 52 m²/g, or about 43 to 69 m²/g, or about 95 to 115 m²/g, or about 70 to 90 m²/g, or about 110 to 140 m²/g, or about 125 to 155 m²/g.

In preferred embodiments of the curable one-component composition according to the invention, the highly structured carbon black has a Brunauer-Emmett-Teller (BET) surface area (nitrogen absorption, nitrogen surface area (NSA), ASTM D 6556) to cetytrimethyl ammonium bromide absorption (CTAB number, statistical thickness surface area (STSA), ASTM D 3765) (BET:STSA ratio) of at least about 1.01, preferably at least about 1.02, more preferably at least about 1.03, still more preferably at least about 1.04, yet more preferably at least about 1.05, even more preferably at least about 1.06, most preferably at least about 1.07, and in particular at least about 1.08.

In preferred embodiments of the curable one-component composition according to the invention, the highly structured carbon black has an oil absorption number (OAN, ASTM D 2414)
of at least about 50 ml/100 g, preferably at least about 60 ml/100 g, more preferably at least about 70 ml/100 g, still more preferably at least about 80 ml/100 g, yet more preferably at least about 90 ml/100 g, even more preferably at least about 100 ml/100 g, most preferably at least about 110 ml/100 g, or at least about 115 ml/100 g, and in particular at least about 120 ml/100 g, or at least about 150 ml/100 g; and/or
of at most about 310 ml/100 g, preferably at most about 290 ml/100 g, more preferably at most about 270 ml/100 g, still more preferably at most about 250 ml/100 g, yet more preferably at most about 230 ml/100 g, even more preferably at most about 210 ml/100 g, most preferably at most about 190 ml/100 g, and in particular at most about 170 ml/100 g; and/or
within the range of about 50±25 ml/100 g, or 60±25 ml/100 g, or 70±25 ml/100 g, or 80±25 ml/100 g, or 90±25 ml/100 g, or 100±25 ml/100 g, or 110±25 ml/100 g, or 120±25 ml/100 g, or 130±25 ml/100 g, or 140±25 ml/100 g, or 150±25 ml/100 g, or 160±25 ml/100 g, or 170±25 ml/100 g, or 180±25 ml/100 g, or 190±25 ml/100 g, or 200±25 ml/100 g, or 210±25 ml/100 g, or 220±25 ml/100 g, or 230±25 ml/100 g, or 240±25 ml/100 g, or 250±25 ml/100 g, or 260±25 ml/100 g, or 270±25 ml/100 g, or 280±25 ml/100 g, or 290±25 ml/100 g, or 300±25 ml/100 g, or 310±25 ml/100 g.

In preferred embodiments of the curable one-component composition according to the invention, the highly structured carbon black has a dibutyl phthalate absorption (24M4-DBP number, dibutyl phthalate absorption (DBA), ASTM D 2414)
of at least about 50 ml/100 g, preferably at least about 60 ml/100 g, more preferably at least about 70 ml/100 g, still more preferably at least about 80 ml/100 g, yet more preferably at least about 90 ml/100 g, even more preferably at least about 100 ml/100 g, most preferably at least about 110 ml/100 g, and in particular at least about 120 ml/100 g; and/or
of at most about 200 ml/100 g, preferably at most about 190 ml/100 g, more preferably at most about 180 ml/100 g, still more preferably at most about 170 ml/100 g, yet more preferably at most about 160 ml/100 g, even more preferably at most about 150 ml/100 g, most preferably at most about 140 ml/100 g, and in particular at most about 130 ml/100 g; and/or
within the range of about 50±25 ml/100 g, or 60±25 ml/100 g, or 70±25 ml/100 g, or 80±25 ml/100 g, or 90±25 ml/100 g, or 100±25 ml/100 g, or 110±25 ml/100 g, or 120±25 ml/100 g, or 130±25 ml/100 g, or 140±25 ml/100 g, or 150±25 ml/100 g.

In preferred embodiments of the curable one-component composition according to the invention, the highly structured carbon black has an average primary particle size (ASTM D 3849-14a)
of at least about 1.0 nm, preferably at least about 2.0 nm, more preferably at least about 3.0 nm, still more preferably at least about 4.0 nm, yet more preferably at least about 5.0 nm, even more preferably at least about 6.0 nm, most preferably at least about 7.0 nm, and in particular at least about 8.0 nm; and/or
of at most about 100 nm, preferably at most about 90 nm, more preferably at most about 80 nm, still more preferably at most about 70 nm, yet more preferably at most about 60 nm, even more preferably at most about 50 nm, most preferably at most about 40 nm, and in particular at most about 30 nm; and/or
within the range of from about 1.0 to 10 nm, or about 11 to 19 nm, or about 20 to 25 nm, or about 26 to 30 nm, or about 31 to 39 nm, or about 40 to 48 nm, or about 49 to 60 nm, or about 61 to 100 nm.

In preferred embodiments of the curable one-component composition according to the invention, the highly structured carbon black has a surface energy (based upon measuring dynamic water vapor sorption, preferably as described in EP 3 544 097 A1)
of at least about 1.0 mJ/m², preferably at least about 2.5 mJ/m², more preferably at least about 5.0 mJ/m²; and/or
of at most about 70 mJ/m², preferably at most about 40 mJ/m², more preferably at most about 15 mJ/²; and/or
within the range of about 5.0±4.0 mJ/m², or 7.5±4.0 mJ/m², or 10±4.0 mJ/m², or 12.5±4.0 mJ/m², or 15±4.0 mJ/m².

In preferred embodiments of the curable one-component composition according to the invention, the highly structured carbon black has an L a crystallite size (based upon Raman spectroscopy, resonance bands at about 1340 cm⁻¹ (D band) and 1580 cm⁻¹ (G band), preferably as described in EP 3 544 097 A1)
of at least about 5.0 Å, preferably at least about 7.5 Å, more preferably at least about 10 Å, still more preferably at least about 12.5 Å, yet more preferably at least about 15 Å, even more preferably at least about 17.5 Å, and most preferably at least about 20 Å; and/or
of at most about 42.5 Å, preferably at most about 40 Å, more preferably at most about 37.5 Å, still more preferably at most about 35 Å, yet more preferably at most about 32.5 Å, even more preferably at most about 30 Å, and most preferably at most about 27.5 Å; and/or
within the range of about 10±7.5 Å, or 12.5±7.5 Å, or 15±7.5 Å, or 17.5±7.5 Å, or 20±7.5 Å, or 22.5±7.5 Å, or 25±7.5 Å, or 27.5±7.5 Å, or 30±7.5 Å, or 32.5±7.5 Å, or 35±7.5 A.

The highly structured carbon black can have a high degree of graphitization, as indicated by a high % crystallinity, which is obtained from Raman measurements as a ratio of the area of the G band and the areas of G and D bands (IG/IG+D). In certain embodiments, the highly structured carbon black particles have % crystallinities (IG IG+D) ranging from 35% to 45%, as determined by Raman spectroscopy. The % crystallinity (IG/IG+D) can have or include, for example, one of the following ranges: from 35% to 43%, or from 35% to 41%, or from 35% to 39%, or from 37% to 45%, or from 37% to 43%, or from 37% to 41%, from 39% to 45%, or from 39% to 43%, or from 41% to 45%.

In preferred embodiments of the curable one-component composition according to the invention, the highly structured carbon black has an water content (determined according to Karl Fischer method) of at most about 1000 ppm, preferably at most about 500 ppm, more preferably at most about 100 ppm, still more preferably at most about 50 ppm.

In preferred embodiments of the curable one-component composition according to the invention, the highly structured carbon black has a relatively low oxygen content, which can be indicative of the particles' purity and electrical conductivity properties. In some embodiments, the highly structured carbon black has an oxygen content of less than or equal to about 1.0 wt.-%, or less than or equal to about 0.8 wt.-%, or less than or equal to about 0.6 wt.-%, or less than or equal to about 0.4 wt.-%. The oxygen content can have or include, for example, one of the following ranges: from about 0.01 to 1.0 wt.-%, or from about 0.03 to 1.0 wt.-%, or from about 0.03 to 0.8 wt.-%, or from about 0.03 to 0.6 wt.-% or from about 0.03 to 0.4 wt.-%. The oxygen content can be determined by inert gas fusion in which a sample of carbon black particles are exposed to very high temperatures (e.g., about 3000° C.) under inert gas conditions. The oxygen in the sample reacts with carbon to form CO and CO₂, which can be monitored by a non-dispersive infrared technique. The total oxygen content is reported in weight percent relative to the total weight of the sample. Various oxygen analyzers based on the inert gas fusion methods are known in the art and commercially available, for example a LECO® TCH₆₀₀ analyzer.

In preferred embodiments of the curable one-component composition according to the invention, the weight content of the highly structured carbon black is at least about 0.05 wt.-%, preferably at least about 0.1 wt.-%, more preferably at least about 0.15 wt.-%, still more preferably at least about 0.2 wt.-%, yet more preferably at least about 0.25 wt.-%, even more preferably at least about 0.3 wt.-%, most preferably at least about 0.4 wt.-%, and in particular at least about 0.5 wt.-%; in each case relative to the total weight of the curable one-component composition.

In preferred embodiments of the curable one-component composition according to the invention, the weight content of the highly structured carbon black is at most 18 wt.-%.

In preferred embodiments of the curable one-component composition according to the invention, the weight content of the highly structured carbon black is
at least about 3.0 wt.-%, preferably at least about 4.0 wt.-%, more preferably at least about 5.0 wt.-%, still more preferably at least about 6.0 wt.-%, yet more preferably at least about 7.0 wt.-%, even more preferably at least about 8.0 wt.-%, most preferably at least about 9.0 wt.-%, and in particular at least about 10 wt.-%; and/or
at most about 27 wt.-%, preferably at most about 26 wt.-%, more preferably at most about 25 wt.-%, still more preferably at most about 24 wt.-%, yet more preferably at most about 23 wt.-%, even more preferably at most about 22 wt.-%, most preferably at most about 21 wt.-%, and in particular at most about 20 wt.-%; preferably less than 20 wt.-%; more preferably at most 19 wt.-%, still more preferably at most 18 wt.-%; and/or
within the range of from about 5.0 to 25 wt.-%, preferably from about 10 to 20 wt.-%; in each case relative to the total weight of the curable one-component composition.

The curable one-component composition according to the invention preferably comprises polycarbonate. The curable one-component composition according to the invention may comprise a single polycarbonate or a mixture of two or more polycarbonates. In case of the presence of two or more polycarbonates, all weights and percentages refer to the total weight of all polycarbonates that are contained in the curable one-component composition.

In preferred embodiments, the polycarbonate comprises or essentially consist of a polycarbonate polyol, preferably polycarbonate diol.

Polycarbonate polyols are preferably synthesized from CO₂ and epoxides, the CO₂ is sequestered in the backbone of a polycarbonate polyol by reaction with an epoxide during synthesis. Many different substituents can be used, to provide a broad range of polycarbonate polyol molecular structures:

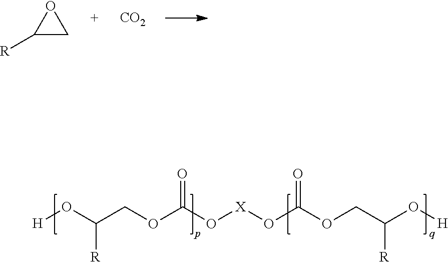

The functionality of a polycarbonate polyol can also be chosen as desired, by using any one of many different possible starting molecules X. For example, a diol or diacid as starting molecule X provides a polycarbonate diol, a triol or triacid as starting molecule X provides a polycarbonate triol, and a tetrol or tetraacid as starting molecule X provides a polycarbonate tetrol.

It has been surprisingly found that polycarbonate diols, i.e. polycarbonates derived from difunctional starting molecules X having terminal hydroxyl groups, provide a quick fixation after heating and recrystallizing as they can be liquids and crystalline solids.

Further, it has been surprisingly found that utilization of polycarbonates having various melting points allows for adjusting rheology like shear thinning, sag resistance, recovery and tailing for improved application properties in mass application environment requiring short handling times. It has been surprisingly found that polycarbonates, especially polycarbonate diols, further enhance multi-substrate adhesion, durability and high strength performance.

In preferred embodiments, the polycarbonate diol has general formula (III)

HO—R1-[O—C(═O)—O—R2]ₙ—OH (III);

wherein R1 and R2 are independently of one another selected from the group consisting of —C₁₋₁₂-alkylene-, -C₄₋₁₀-cycloalkylene-, -C₁₋₁₂-alkylene-C₄₋₁₀-cycloalkylene-C₁₋₁₂-alkylene-, -C₆₋₁₀-aryl-, -C₁₋₁₂ -alkylene-C₆₋₁₀-aryl-C₁₋₁₂-alkylene-, —C₆₋₁₀- aryl-C₁₋₁₂-alkylene-C₆₋₁₀-aryl-, —[C₁₋₆-alkylene-O]ₘ—C₁₋₆-alkylene-, —[C₁₋₆-alkylene-O]ₘ—C₆₋₁₀-aryl-, —C(═O)—O—C₁₋₁₂-alkylene-, —C(═O)—O—C₁₋₆-alkylene-O—C₁₋₆-alkylene-, —C(═O)—O—C₆₋₁₀-aryl-, —C(═O)—O—C₁₋₆-alkylene-C₆₋₁₀-aryl-, —C(═O)—O—C₁₋₆-alkylene-O—C₆₋₁₀-aryl-, wherein m is an integer within the range of from 1 to 10; and
wherein n is an integer within the range of from 1 to 25, preferably 1, 2, 3, or 4.

In other preferred embodiments, the polycarbonate diol has general formula (IV)

H—[O—CHR1CH₂—O—C(═O)]ₚ—O—X—O—[C(═O)—O—CH₂—CHR2-—O]_{q}—H (IV);

wherein
X is selected from the group consisting of -C₁₋₁₂-alkylene-, -C₄₋₁₀-cycloalkylene-, -C₁₋₁₂-alkylene-C₄₋₁₀cycloalkylene-C₁₋₂-alkylene-, -C₁₋₁₂-alkylene-C₆₋₁₀-aryl- C₁₋₁₂-alkylene-, -C₆₋₁₀-aryl-C₁₋₁₂alkylene-C₆₋₁₀-aryl-, —C(═O)-C₁₋₁₂-alkylene-C(═O)—, —C(═O)-C₄₋₁₀-cycloalkylene-C(═O)—, —C(═O)-C₁₋₁₂-alkylene-C₄₋₁₀-cycloalkylene-C₁₋₁₂-alkylene-C(═O)—, —C(═O)-C₆₋₁₀-aryl-C(═O)—, —C(═O)-C₁₋₁₂-alkylene-C₆₋₁₀-aryl-C₁₋₁₂-alkylene-C(—O—)—, and —C(—O)-C₆₋₁₀-aryl-C₁₋₁₂-alkylene-C₆₋₁₀-aryl-C(—O)—;
R1 and R2 are independently of one another selected from the group consisting of -C₁₋₁₂-alkyl, -C₄₋₁₀cycloalkyl, -C₁₋₁₂-alkylene-C₁₄₋₁₀-cycloalkyl, -C₆₋₁₀-aryl-, and -C₁₋₁₂-alkylene-C₆₋₁₀-aryl; and
p and q independently of one another are an integer within the range of from 1 to 25, preferably 1, 2, 3, or 4.

In preferred embodiments, the polycarbonate, preferably the polycarbonate diol, has a weight average molecular weight
of at least about 500 g/mol, preferably at least about 530 g/mol, more preferably at least about 560 g/mol, still more preferably at least about 590 g/mol, yet more preferably at least about 620 g/mol, even more preferably at least about 650 g/mol, most preferably at least about 680 g/mol, and in particular at least about 710 g/mol, or at least about 1000 g/mol, or at least about 1500 g/mol; and/or
of at most about 10000 g/mol, preferably at most about 9700 g/mol, more preferably at most about 9400 g/mol, still more preferably at most about 9100 g/mol, yet more preferably at most about 8800 g/mol, even more preferably at most about 8500 g/mol, most preferably at most about 8200 g/mol, and in particular at most about 7900 g/mol, or at most 6000 g/mol, or at most 4000 g/mol, or at most 3000 g/mol; and/or
within the range of from about 500 to 10000 g/mol; preferably within the range of about 1000±500 g/mol, or 1500±1000 g/mol, or 2000±1000 g/mol, or 2500±1000 g/mol, or 3000±1000 g/mol, or 3500±1000 g/mol, or 4000±1000 g/mol, or 4500±1000 g/mol, or 5000±1000 g/mol, or 5500±1000 g/mol, or 6000±1000 g/mol, or 6500±1000 g/mol, or 7000±1000 g/mol, or 7500±1000 g/mol, or 8000±1000 g/mol, or 8500±1000 g/mol, or 9000±1000 g/mol, or 9500±1000 g/mol, or 10000±1000 g/mol.

In preferred embodiments, the polycarbonate, preferably the polycarbonate diol, has a melting point
of at least about 0° C., preferably at least about 10° C., more preferably at least about 20° C., still more preferably at least about 30° C., yet more preferably at least about 40° C., even more preferably at least about 50° C., most preferably at least about 50° C., and in particular at least about 60° C.; and/or
of at most about 200° C., preferably at most about 190° C., more preferably at most about 180° C., still more preferably at most about 170° C., yet more preferably at most about 1600° C., even more preferably at most about 150° C., most preferably at most about 140° C., and in particular at most about 130° C.; and/or
within the range of from about 0 to 200° C.; preferably within the range of about 10±5° C., or 15±10° C., or 20±10° C., or 25±10° C., or 30±10° C., or 35±10° C., or 40±10° C., or 45±10° C., or 50±10° C., or 55±10° C., or 60±10° C., or 65±10° C., or 70±10° C., or 75±10° C., or 80±10° C., or 85±10° C., or 90±10° C., or 95±10° C., or 100±10° C.

In preferred embodiments, the polycarbonate, preferably the polycarbonate diol, has a melting point
of at least about −25° C., preferably at least about −15° C., more preferably at least about -5.0° C., still more preferably at least about 5.0° C., yet more preferably at least about 15° C., even more preferably at least about 25° C., most preferably at least about 35° C., and in particular at least about 45° C.; and/or
of at most about 120° C., preferably at most about 115° C., more preferably at most about 110° C., still more preferably at most about 105° C., yet more preferably at most about 100° C., even more preferably at most about 95° C., most preferably at most about 90° C., and in particular at most about 85° C.; and/or
within the range of from about −20 to 120° C.

In preferred embodiments, the polycarbonate, preferably the polycarbonate diol, has a Brookfield viscosity at 75° C. (ASTM D789, D4878)
of at least about 500 mPa·s, preferably at least about 1,000 mPa·s, more preferably at least about 1,500 mPa·s, still more preferably at least about 2,000; and/or
of at most about 5,000 mPa·s, preferably at most about 4,000 mPa·s, more preferably at most about 3,500 mPa·s, still more preferably at most about 3,000 mPa·s; and/or
within the range of from about 500 to 5,000 mPa·s, preferably about 1,500 to 3,500 mPa·s, more preferably about 2,000 to 3,000 mPa·s.

In preferred embodiments, the polycarbonate, preferably the polycarbonate diol, has a hydroxyl number (ASTM D4274)
of at least about 25 mg KOH/g, preferably at least about 35 mg KOH/g, more preferably at least about 45 mg KOH/g, still more preferably at least about 55; and/or
of at most about 95 mg KOH/g, preferably at most about 85 mg KOH/g, more preferably at most about 75 mg KOH/g, still more preferably at most about 65 mg KOH/g; and/or
within the range of from about 25 to 95 mg KOH/g, preferably about 40 to 70 mg KOH/g, more preferably about 50 to 60 mg KOH/g.

In preferred embodiments, the polycarbonate, preferably the polycarbonate diol, has an acid value (ASTM D4662) of at most about 0.6 mg KOH/g, preferably at most about 0.4 mg KOH/g, more preferably at most about 0.2 mg KOH/g, still more preferably at most about 0.1 mg KOH/g.

In preferred embodiments of the curable one-component composition according to the invention, the weight content of the polycarbonate, preferably the polycarbonate diol, is
at least about 0.4 wt.-%, preferably at least about 0.6 wt.-%, more preferably at least about 0.8 wt.-%, still more preferably at least about 1.0 wt.-%, yet more preferably at least about 1.5 wt.-%, even more preferably at least about 2.0 wt.-%, most preferably at least about 3.5 wt.-%, and in particular at least about 5.0 wt.-%; or at least about 6.0 wt.-%, preferably at least about 8.0 wt.-%, more preferably at least about 10 wt.-%, still more preferably at least about 12 wt.-%, yet more preferably at least about 14 wt.-%, even more preferably at least about 16 wt.-%, most preferably at least about 18 wt.-%, and in particular at least about 20 wt.-%; and/or
at most about 50 wt.-%, preferably at most about 45 wt.-%, more preferably at most about 40 wt.-%, still more preferably at most about 38 wt.-%, yet more preferably at most about 36 wt.-%, even more preferably at most about 34 wt.-%, most preferably at most about 32 wt.-%, and in particular at most about 31 wt.-%; or at most about 30 wt.-%, preferably at most about 27 wt.-%, more preferably at most about 24 wt.-%, still more preferably at most about 22 wt.-%, yet more preferably at most about 18 wt.-%, even more preferably at most about 16 wt.-%, most preferably at most about 12 wt.-%, and in particular at most about 10 wt.-%; and/or
within the range of from about 0.4 to 30 wt.-%, preferably from about 5.0 to 10 wt.-%;
   in each case relative to the total weight of the curable one-component composition.

The curable one-component composition according to the invention preferably comprises fumed silica. The curable one-component composition according to the invention may comprise a single kind of fumed silica or a mixture of two or more kinds of fumed silica. In case of the presence of two or more kinds of fumed silica, all weights and percentages refer to the total weight of all kinds of fumed silica that are contained in the curable one-component composition.

It has been surprisingly found that fumed silica, especially certain grades of fumed silica, have a positive effect on multi-substrate adhesion including glass, durability and high strength.

Preferably, the fumed silica is hydrophobic fumed silica. Hydrophobic types of fumed silica are commercially available, e.g. Huifull® HB-132, HB-139, or HB-152; or Cab-O-Sil® TS-720, TS-710, TS-610 or TS-530. Hydrophobicity is typically achieved by surface modification with various treatment agents such as polydimethylsiloxane (PDMS), hexamethyldisilazane (HDMZ), dimethyldichlorosilane (DiMeDi , DDS). Fumed silica treated with PDMS is preferred.

In preferred embodiments, the fumed silica has a Brunauer-Emmett-Teller (BET) surface area (ISO 9277)
of at least about 50 m²/g, preferably at least about 60 m²/g, more preferably at least about 70 m²/g, still more preferably at least about 80 m²/g, yet more preferably at least about 90 m²/g, even more preferably at least about 100 m²/g, most preferably at least about 110 m²/g, and in particular at least about 120 m²/g; and/or
of at most about 600 m²/g, preferably at most about 580 m²/g, more preferably at most about 560 m²/g, still more preferably at most about 540 m²/g, yet more preferably at most about 520 m²/g, even more preferably at most about 500 m²/g, most preferably at most about 480 m²/g, and in particular at most about 460 m²/g; and/or
within the range of about 50±25 m²/g, or 75±25 m²/g, or 100±25 m²/g, or 125±25 m²/g, or 150±25 m²/g, or 175±25 m²/g, or 200±25 m²/g, or 225±25 m²/g, or 250±25 m²/g, or 275±25 m²/g, or 300±25 m²/g, or 325±25 m²/g, or 350±25 m²/g, or 375±25 m²/g, or 400±25 m²/g, or 425±25 m²/g, or 450±25 m²/g, or 475±25 m²/g, or 500±25 m²/g, or 525±25 m²/g, or 550±25 m²/g, or 575±25 m²/g, or 600±25 m²/g; preferably about 180 to 220 m²/g.

In particularly preferred embodiments, the fumed silica has a Brunauer-Emmett-Teller (BET) surface area (ISO 9277) within the range of from about 150 to 250 m²/g, preferably about 160 to 240 m²/g, more preferably about 170 to 230 m²/g.

In preferred embodiments, the fumed silica has a mean primary particle size determined by photon correlation spectroscopy (PCS)
of at least about 1.0 nm, preferably at least about 2.0 nm, more preferably at least about 3.0 nm, still more preferably at least about 4.0 nm, yet more preferably at least about 5.0 nm, even more preferably at least about 6.0 nm, most preferably at least about 7.0 nm, and in particular at least about 8.0 nm; and/or
of at most about 100 nm, preferably at most about 90 nm, more preferably at most about 80 nm, still more preferably at most about 70 nm, yet more preferably at most about 60 nm, even more preferably at most about 50 nm, most preferably at most about 40 nm, and in particular at most about 30 nm; and/or
within the range of about 10±5 nm, or 15±5 nm, or 20±5 nm, or 25±5 nm, or 30±5 nm, or 35±5 nm, or 40±5 nm, or 45±5 nm, or 50±5 nm.

In preferred embodiments, the fumed silica has a tamped density (ISO 787/11)
of at least about 40 g/l, preferably at least about 50 g/l, more preferably at least about 60 g/l, still more preferably at least about 70 g/l, yet more preferably at least about 80 g/l, even more preferably at least about 90 g/l, most preferably at least about 100 g/l, and in particular at least about 110 g/1; and/or
of at most about 250 g/l, preferably at most about 225 g/l, more preferably at most about 200 g/l, still more preferably at most about 175 g/l, yet more preferably at most about 150 g/l, even more preferably at most about 100 g/l, most preferably at most about 80 g/l, and in particular at most about 60 g/l; and/or
within the range of about 50±25 g/l, or 60±25 g/l, or 70±25 g/l, or 80±25 g/l, or 90±25 g/l, or 100±25 g/l, or 110±25 g/l, or 120±25 g/l, or 130±25 g/l, or 140±25 g/l, or 150±25 g/l.

In particularly preferred embodiments, the fumed silica has a tamped density (DIN EN ISO 78711) within the range of about 50±20 g/l, preferably about 50±10 g/l, more preferably about 50±5.0 g/l.

In particularly preferred embodiments, the fumed silica has a density (DIN 51757) within the range of about 2.3±0.3 g/cm³, preferably about 2.3±0.2 g/cm³, more preferably about 2.3±0.1 g/cm².

In preferred embodiments, the fumed silica has a dioctyl adipate absorption (ISO CD 19246)
of at least about 200 ml/100 g, preferably at least about 210 ml/100 g, more preferably at least about 220 ml/100 g, still more preferably at least about 230 ml/100 g, yet more preferably at least about 240 ml/100 g, even more preferably at least about 250 ml/100 g, most preferably at least about 260 ml/100 g, and in particular at least about 270 ml/100 g; and/or
of at most about 350 ml/100 g, preferably at most about 340 ml/100 g, more preferably at most about 330 ml/100 g, still more preferably at most about 320 ml/100 g, yet more preferably at most about 310 ml/100 g, even more preferably at most about 300 ml/100 g, most preferably at most about 290 ml/100 g, and in particular at most about 280 ml/100 g; and/or
within the range of about 100±25 ml/100 g, or 125±25 ml/100 g, or 150±25 ml/100 g, or 175±25 ml/100 g, or 200±25 ml/100 g, or 225±25 ml/100 g, or 250±25 ml/100 g, or 275±25 ml/100 g, or 300±25 ml/100 g, or 325±25 ml/100 g, or 350±25 ml/100 g.

In preferred embodiments, the fumed silica is untreated.

In preferred embodiments, the fumed silica is organically modified, preferably treated with optionally functionalized halotrialkylsilane or optionally functionalized dihalodialkylsilane, more preferably with trimethyl silyl groups; still more preferably with polydimethylsiloxane.

In preferred embodiments of the curable one-component composition according to the invention, the weight content of the fumed silica is
at least about 0.1 wt.-%, preferably at least about 0.2 wt.-%, more preferably at least about 0.3 wt.-%, still more preferably at least about 0.4 wt.-%, yet more preferably at least about 0.5 wt.-%, even more preferably at least about 0.6 wt.-%, most preferably at least about 0.8 wt.-%, and in particular at least about 1.0 wt.-%; or at least about 3.0 wt.-%, preferably at least about 4.0 wt.-%, more preferably at least about 5.0 wt.-%, still more preferably at least about 6.0 wt.-%, yet more preferably at least about 7.0 wt.-%, even more preferably at least about 8.0 wt.-%, most preferably at least about 9.0 wt.-%, and in particular at least about 10 wt.-%; and/or
at most about 44 wt.-%, preferably at most about 42 wt.-%, more preferably at most about 40 wt.-%, still more preferably at most about 38 wt.-%, yet more preferably at most about 36 wt.-%, even more preferably at most about 34 wt.-%, most preferably at most about 32 wt.-%, and in particular at most about 30 wt.-%; or at most about 27 wt.-%, preferably at most about 26 wt.-%, more preferably at most about 25 wt.-%, still more preferably at most about 24 wt.-%, yet more preferably at most about 23 wt.-%, even more preferably at most about 22 wt.-%, most preferably at most about 21 wt.-%, and in particular at most about 20 wt.-%; and/or
within the range of from about 5 to 45 wt.-% or from about 5 to 30 wt.-%, preferably from about 10 to 25 wt.-%;
   in each case relative to the total weight of the curable one-component composition.

In preferred embodiments of the curable one-component composition according to the invention, the total weight content of the highly structured carbon black and the fumed silica (both together) is
at least about 5.0 wt.-%, preferably at least about 7.5 wt.-%, more preferably at least about 10 wt.-%, still more preferably at least about 12.5 wt.-%, yet more preferably at least about 15 wt.-%, even more preferably at least about 17.5 wt.-%, most preferably at least about 20 wt.-%, and in particular at least about 22.5 wt.-%; and/or
at most about 60 wt.-%, preferably at most about 57.5 wt.-%, more preferably at most about 55 wt.-%, still more preferably at most about 52.5 wt.-%, yet more preferably at most about 50 wt.-%, even more preferably at most about 47.5 wt.-%, most preferably at most about 45 wt.-%, and in particular at most about 40 wt.-%; and/or
within the range of about 10±5.0 wt.-%, or 15±10 wt.-%, or 20±10 wt.-%, or 25±10 wt.-%, or 30±10 wt.-%, or 35±10 wt.-%, or 40±10 wt.-%, or 45±10 wt.-%, or 50±10 wt.-%, or 55±10 wt.-%, or 60±10 wt.-%;
   in each case relative to the total weight of the curable one-component composition.

The curable one-component composition according to the invention preferably comprises plasticizer. The curable one-component composition according to the invention may comprise a single plasticizer or a mixture of two or more plasticizers. In case of the presence of two or more plasticizers, all weights and percentages refer to the total weight of all plasticizers that are contained in the curable one-component composition.

Preferably, the plasticizer comprises or essentially consist of a copolymer polyol, preferably a copolymer of a polymeric material grafted onto a main polyol chain, more preferably a SAN (styrene/acrylonitrile) or an AN (acrylonitrile) grafted onto a polyether polyol or onto a polyester polyol.

Preferably, the plasticizer comprises or essentially consist of a SAN (styrene/acrylonitrile) grafted onto a polyol.

In preferred embodiments, the polyol is a polyether polyol selected from polyoxymethylene, polyoxyethylene, polyoxypropylene, and polyoxybutylene.

In preferred embodiments, the polyol is a polyester polyol, preferably an ester of a polyol of two to five carbon atoms and one or more aliphatic saturated organic acids.

Preferably, the copolymer polyol is selected from the group consisting of SAN-grafted polyether polyols and SAN-grafted polyester polyols; preferably SAN-grafted polyoxymethylene, SAN-grafted polyoxyethylene, SAN-grafted polyoxypropylene, and SAN-grafted polyoxybutylene.

In preferred embodiments, the plasticizer has a weight average molecular weight
of at least about 100,000 g/mol, preferably at least about 120,000 g/mol, more preferably at least about 140,000 g/mol, still more preferably at least about 160,000 g/mol, yet more preferably at least about 180,000 g/mol, even more preferably at least about 200,000 g/mol, most preferably at least about 220,000 g/mol, and in particular at least about 240,000 g/mol; and/or
of at most about 500,000 g/mol, preferably at most about 480,000 g/mol, more preferably at most about 460,000 g/mol, still more preferably at most about 440,000 g/mol, yet more preferably at most about 420,000 g/mol, even more preferably at most about 400,000 g/mol, most preferably at most about 380,000 g/mol, and in particular at most about 360,000 g/mol; and/or
within the range of from about 100,000 to 500,000 g/mol.

In preferred embodiments, the curable one-component composition according to the invention comprises a polyol plasticizer. Suitable polyol plasticizers are known to the skilled person and commercially available.

Preferably, the polyol plasticizer has a weight average molecular weight within the range of from about 2,000 to 20,000 g/mol.

Preferably, the polyol plasticizer is
selected from glycerol, sorbitol, ethylene glycol, diethylene glycol, triethylene glycol, tetraethylene glycol, polyethylene glycol, propylene glycol, dipropylene glycol, tripropylene glycol, tetrapropylene glycol, and polypropylene glycol; or
an esterified polyol plasticizer, preferably an ester of a polyol of two to five carbon atoms and one or more aliphatic saturated organic acids.

Other preferred plasticizers that may be present in the curable one-component composition according to the invention, optionally in addition to one or more of the plasticizers described above, include but are not limited to dioctyl terephthalate (DOTP), 1,2-cyclohexane dicarboxylic acid esters such as the diisononyl ester (DINCH), diethylene glycol dibenzoate (DE), dipropylene glycol dibenzoate (DPGDB) and bio-based plasticizers.

While being less preferred, it is also contemplated that the plasticizer may be a phthalate plasticizer.

Thus, in preferred embodiments, the plasticizer is selected from the group consisting of
phthalates; preferably dioctyl terephthalate (DOTP), or diisononylphthalate (DINP);
1,2-cyclohexane dicarboxylic acid esters; preferably 1,2-cyclohexane dicarboxylic acid diisononyl ester (DINCH);
benzoates; preferably diethylene glycol dibenzoate (DE), or dipropylene glycol dibenzoate (DPGDB); and
bio-based plasticizers.

In preferred embodiments of the curable one-component composition according to the invention, the weight content of the plasticizer is
at least about 2.0 wt.-%, preferably at least about 3.0 wt.-%, more preferably at least about 4.0 wt.-%, still more preferably at least about 5.0 wt.-%, yet more preferably at least about 6.0 wt.-%, even more preferably at least about 7.0 wt.-%, most preferably at least about 8.0 wt.-%, and in particular at least about 10 wt.-%; and/or
at most about 50 wt.-%, preferably at most about 45 wt.-%, more preferably at most about 40 wt.-%, still more preferably at most about 37 wt.-%, yet more preferably at most about 34 wt.-%, even more preferably at most about 31 wt.-%, most preferably at most about 28 wt.-%, and in particular at most about 25 wt.-%; and/or
within the range of from about 2.0 to 50 wt.-%, preferably from about 10 to 25 wt.-%;

in each case relative to the total weight of the curable one-component composition.

The curable one-component composition according to the invention preferably comprises silane compatibilizer. The curable one-component composition according to the invention may comprise a single silane compatibilizer or a mixture of two or more silane compatibilizers. In case of the presence of two or more silane compatibilizers, all weights and percentages refer to the total weight of all silane compatibilizers that are contained in the curable one-component composition. Silane compatibilizers are known to the skilled person and commercially available.

Preferably, the silane compatibilizer comprises or essentially consist of a functional silane.

In preferred embodiments, the silane compatibilizer is
an amino silane, preferably a diamino-functional silane or a multifunctional aminosilane, more preferably N-2-aminoethyl-3-aminopropyltrimethoxysilane (DAMO); or a bifunctional silane possessing a reactive primary amino group and hydrolyzable ethoxysilyl groups, more preferably 3-aminopropyltriethoxysilane (AMEO);
a vinyl silane, preferably a bifunctional organosilane possessing a vinyl group and a hydrolyzable trimethoxysilyl group (VTMO) or a bifunctional organosilane possessing a vinyl group and a hydrolyzable 2-methoxy-ethoxy-silyl group (VTMOEO); or
a mixture thereof.

Trimethoxy(vinyl)silane (VTMO) is a particularly preferred silane compatibilizer and additionally may act as moisture scavenger.

N-2-aminoethyl-3-aminopropyltrimethoxysilane (DAMO) is another particularly preferred silane compatibilizer.

In preferred embodiments, the curable one-component composition according to the invention contains as silane compatibilizer a combination of trimethoxy(vinyl)silane (VTMO) and N-2-aminoethyl-3-aminopropyltrimethoxysilane (DAMO).

In preferred embodiments, the silane compatibilizer comprises a hydrolyzable group and a nonhydrolyzable group.

Preferably, the hydrolyzable group is a hydrolyzable silyl group as defined above in connection with the silyl-modified prepolymer according to the invention.

Preferably, the nonhydrolyzable group is selected from -C₁₋₁₂-alkyl, —CH═CH₂, —NH₂, —NHC₁₋₁₂-alkyl, and —N(C₁₋₁₂-alkyl)₂.

In preferred embodiments of the curable one-component composition according to the invention, the weight content of the silane compatibilizer is
at least about 0.05 wt.-%, preferably at least about 0.10 wt.-%, more preferably at least about 0.15 wt.-%, still more preferably at least about 0.2 wt.-%, yet more preferably at least about 0.25 wt.-%, even more preferably at least about 0.3 wt.-%, most preferably at least about 0.4 wt.-%, and in particular at least about 0.5 wt.-%; and/or
at most about 6.0 wt.-%, preferably at most about 5.5 wt.-%, more preferably at most about 5.0 wt.-%, still more preferably at most about 4.5 wt.-%, yet more preferably at most about 4.0 wt.-%, even more preferably at most about 3.5 wt.-%, most preferably at most about 3.0 wt.-%, and in particular at most about 2.5 wt.-%; and/or
within the range of from about 0 to 5.0 wt.-%, preferably from about 0.5 to 2.5 wt.-%;
   in each case relative to the total weight of the curable one-component composition.

The curable one-component composition according to the invention preferably comprises curing catalyst. The curable one-component composition according to the invention may comprise a single curing catalyst or a mixture of two or more curing catalysts. In case of the presence of two or more curing catalysts, all weights and percentages refer to the total weight of all curing catalysts that are contained in the curable one-component composition. Curing catalysts for humidity-curable prepolymers such as silyl-modified prepolymers are known to the skilled person and commercially available.

In preferred embodiments, the curing catalyst is selected from
carboxylates of metals, preferably of tin, zinc, iron, lead, and cobalt; preferably selected from the group consisting of dibutyltin dilaurate (DBTDL), dibutyltin diacetate, dioctyltin dilaurate, stannous acetate, stannous caprylate, lead naphthenate, zinc caprylate, cobalt naphthenate;
organic bases; preferably selected from the group consisting of ethyl amines, dibutyl amine, hexylamines, and pyridine;
inorganic acids; preferably sulfuric acid or hydrochloric acid;
organic acids; preferably selected from the group consisting of toluene sulfonic acid, acetic acid, stearic acid and maleic acid; and
mixtures of any of the foregoing.

Tin curing catalysts are particularly preferred such as dibutyltin dilaurate (DBTDL), dibutyltin diacetate, or dioctyltin dilaurate.

In preferred embodiments of the curable one-component composition according to the invention, the weight content of the curing catalyst is
at least about 0.1 wt.-%, preferably at least about 0.13 wt.-%, more preferably at least about 0.16 wt.-%, still more preferably at least about 0.19 wt.-%, yet more preferably at least about 0.21 wt.-%, even more preferably at least about 0.24 wt.-%, most preferably at least about 0.27 wt.-%, and in particular at least about 0.3 wt.-%; and/or
at most about 2.2 wt.-%, preferably at most about 2.1 wt.-%, more preferably at most about 2.0 wt.-%, still more preferably at most about 1.9 wt.-%, yet more preferably at most about 1.8 wt.-%, even more preferably at most about 1.7 wt.-%, most preferably at most about 1.6 wt.-%, and in particular at most about 1.5 wt.-%; and/or
within the range of from about 0.1 to 2.0 wt.-%, preferably from about 0.3 to 1.5 wt.-%;
   in each case relative to the total weight of the curable one-component composition.

In preferred embodiments, the curable one-component composition according the invention additionally comprises one or more additives selected from the group consisting of curing accelerators, adhesion promoters, stabilizers, antioxidants, colorants, pigments, fillers, toughening agents, impact modifiers, blowing agents, flame retardants and moisture scavengers.

Preferred pigments or colorants provide sufficient opacity so as to cover the black color of the highly structured carbon black.

Preferably, the adhesion promoter is selected from the group consisting of glycidoxypropyltrimethoxy silane, aminoethyl-aminopropyl-trimethoxy silane, aminopropyltriethoxy silane, hydrolyzed aminoethyl-aminopropylmethyldimethoxy silane, aminopropyltrimethoxy silane, and mixtures thereof.

Preferably, the antioxidant is a 3-(3,5-di-tert-butyl-4-hydroxyphenyl)propionic acid ester, e.g. the methyl ester, the octyl ester (Irganox® 1135), the octadecyl ester (Irganox® 1076, or the pentaerythrityl ester (Irganox ® 1010)), the latter being particularly preferred (pentaerythritol tetrakis[343,5-di-tertbutyl-4-hydroxyphenyl]propionate).

Preferably, the filler is calcium carbonate which may be untreated or treated e.g. with stearic acid. Other suitable fillers include but are not limited to one or more mineral or stone type fillers such as sodium carbonate or magnesium carbonate.

Preferably, the filler is carbon black, with the proviso that it is not “highly structured carbon black”, wherein the non-highly structured carbon black has an oil absorption number (OAN, ASTM D 2414) of less than 115 ml/100 g. Said non-highly structured carbon black is also referred to as “standard carbon black” for the purpose of the specification.

In preferred embodiments of the curable one-component composition according to the invention, the weight content of the filler is within the range of from about 5.0 wt.-% to 70 wt.-%, preferably from about 7.5 wt.-% to 65 wt.-%, more preferably from about 10 wt.-% to 60 wt.-%, still more preferably from about 12 wt.-% to 50 wt.-%, yet more preferably from about 14 wt.-% to 40 wt.-%.

Preferably, the flame retardant is triethyl phosphate.

Preferably, the moisture scavenger is selected from vinyltrimethoxy silane (VTMO), phenyltrimethoxy silane, and mixtures thereof.

Preferably, the curable one-component composition according to the invention is polyurethane free.

Preferably, the curable one-component composition according to the invention does not contain phthalate plasticizers, preferably no phthalate at all.

Particularly preferred curable one-component compositions according to the invention A1 to A4 contain the following components in the following quantities:

| [wt.-] | A1 | A2 | A3 | A4 |
|---|---|---|---|---|
| silyl-modified polyether | 10 to 90 | 20 to 80 | 30 to 70 | 35 to 55 |
| highly structured carbon | 2.5 to 27.5 | 5.0 to 25 | 7.5 to 22.5 | 10 to 20 |
| black, iodine | | | | |
| number ≥95 g/kg, | | | | |
| OAN ≥115 ml/100 g | | | | |
| polycarbonate diol | 0.5 to 30 | 1.0 to 25 | 2.5 to 15 | 5.0 to 10 |
| fumed silica | 0.1 to 40 | 0.5 to 35 | 1.0 to 30 | 2.5 to 25 |
| SAN-grafted onto polyol | 1.0 to 50 | 5.0 to 40 | 7.5 to 30 | 10 to 25 |
| silane compatibilizer | 0 to 5 | 0 to 5 | 0.5 to 2.5 | 0.5 to 2.5 |
| curing catalyst | 0.1 to 2.0 | 0.1 to 2.0 | 0.3 to 1.5 | 0.3 to 1.5 |

In preferred embodiments, the composition according to the invention comprises the following components: silyl-modified prepolymer; highly structured carbon black; silane compatibilizer (e.g. 2aminoethyl-3-amino-propylmethyldi-methoxysilan (DAMO) and/or trimethoxy(vinyl)silane (VTMO); fumed silica (e.g. Aerosil H18); and curing catalyst (e.g. tin catalyst). Preferably, said composition according to the invention additionally comprises one or more of the following: filler (e.g. calcium carbonate treated with stearic acid and/or untreated); plasticizer (e.g. 1,2-cyclohexane dicarboxylic acid diisononyl ester (DINCH)); antioxidant (e.g. Irganox 1010); and/or rheological agent (e.g. TST).

In other preferred embodiments, the composition according to the invention comprises the following components:
humidity-curable prepolymer; preferably silyl-modified prepolymer; more preferably in a weight content within the range of about 42±10 wt.-%, relative to the total weight of the curable one-component composition;
highly structured carbon black; preferably wherein the highly structured carbon black has an oil absorption number (OAN, ASTM D 2414) of at least 115 ml/100 g; more preferably in a weight content within the range of about 17±6.0 wt.-%, relative to the total weight of the curable one-component composition;
fumed silica; preferably hydrophobic fumed silica; more preferably in a weight content within the range of about 1.0±0.5 wt.-%, relative to the total weight of the curable one-component composition;
plasticizer; preferably 1,2-cyclohexane dicarboxylic acid ester, more preferably 1,2-cyclohexane dicarboxylic acid diisononyl ester (DINCH); still more preferably in a weight content within the range of about 20±7.5 wt.-%, relative to the total weight of the curable one-component composition;
optionally, silane compatibilizer; preferably an amino silane, more preferably a diamino-functional silane or a multifunctional aminosilane, still more preferably N-2-aminoethyl-3-aminopropyltrimethoxysilane (DAMO); yet more preferably in a weight content within the range of about 1.0±0.5 wt.-%, relative to the total weight of the curable one-component composition;
optionally, moisture scavenger; preferably vinyltrimethoxy silane (VTMO); more preferably in a weight content within the range of about 0.5±0.25 wt.-%, relative to the total weight of the curable one-component composition;
optionally, curing catalyst; preferably a tin curing catalyst; more preferably in a weight content within the range of about 0.1±0.05 wt.-%, relative to the total weight of the curable one-component composition;
optionally, filler; preferably calcium carbonate; more preferably in a weight content within the range of about 14±5.0 wt.-%, relative to the total weight of the curable one-component composition; and
optionally, antioxidant; preferably in a weight content within the range of about 0.3±0.2 wt.-%, relative to the total weight of the curable one-component composition.

In still other preferred embodiments, the composition according to the invention comprises the following components:
humidity-curable prepolymer; preferably silyl-modified prepolymer; more preferably in a weight content within the range of about 36±10 wt.-%, relative to the total weight of the curable one-component composition;
highly structured carbon black; preferably wherein the highly structured carbon black has an oil absorption number (OAN, ASTM D 2414) of at least 115 ml/100 g; more preferably in a weight content within the range of about 0.5±0.25 wt.-%, relative to the total weight of the curable one-component composition;
polycarbonate; preferably polycarbonate diol, more preferably 1,6 hexanediol based polycarbonate diol; still more preferably in a weight content within the range of about 23±7.0 wt.-%, relative to the total weight of the curable one-component composition;
plasticizer; preferably polyol, more preferably polypropylene glycol; still more preferably in a weight content within the range of about 2.5±1.5 wt.-%, relative to the total weight of the curable one-component composition;
optionally, silane compatibilizer; preferably an amino silane, more preferably a diamino-functional silane or a multifunctional aminosilane, still more preferably N-2-aminoethyl-3-aminopropyltrimethoxysilane (DAMO); yet more preferably in a weight content within the range of about 1.0±0.5 wt.-%, relative to the total weight of the curable one-component composition;
optionally, moisture scavenger; preferably vinyltrimethoxy silane (VTMO); more preferably in a weight content within the range of about 2.0±1.0 wt.-%, relative to the total weight of the curable one-component composition;
optionally, filler; preferably calcium carbonate; more preferably in a weight content within the range of about 41±20 wt.-%, relative to the total weight of the curable one-component composition; and
optionally, flame retardant; preferably triethyl phosphate; more preferably in a weight content within the range of about 2.0±1.0 wt.-%, relative to the total weight of the curable one-component composition.

In still other preferred embodiments, the composition according to the invention comprises the following components:
humidity-curable prepolymer; preferably silyl-modified prepolymer; more preferably in a weight content within the range of about 42±10 wt.-%, relative to the total weight of the curable one-component composition;
optionally, highly structured carbon black; preferably wherein the highly structured carbon black has an oil absorption number (OAN, ASTM D 2414) of at least 115 ml/100 g; more preferably in a weight content within the range of about 10±9.5 wt.-%, relative to the total weight of the curable one-component composition;
fumed silica; preferably hydrophobic fumed silica; preferably in a weight content within the range of about 10±9.0 wt.-%, relative to the total weight of the curable one-component composition;
plasticizer; preferably 1,2-cyclohexane dicarboxylic acid ester or phthalate, more preferably 1,2-cyclohexane dicarboxylic acid diisononyl ester (DINCH) or diisononylphthalate (DINP); still more preferably in a weight content within the range of about 20±10 wt.-%, relative to the total weight of the curable one-component composition;
optionally, silane compatibilizer; preferably an amino silane, more preferably a diamino-functional silane or a multifunctional aminosilane, still more preferably N-2-aminoethyl-3-aminopropyltrimethoxysilane (DAMO); yet more preferably in a weight content within the range of about 1.0±0.5 wt.-%, relative to the total weight of the curable one-component composition;
optionally, moisture scavenger; preferably vinyltrimethoxy silane (VTMO); more preferably in a weight content within the range of about 0.5±0.25 wt.-%, relative to the total weight of the curable one-component composition;
optionally, curing catalyst; preferably a tin curing catalyst; more preferably in a weight content within the range of about 0.1±0.05 wt.-%, relative to the total weight of the curable one-component composition;
optionally, filler; preferably calcium carbonate and/or carbon black, wherein the carbon black preferably has an oil absorption number (OAN, ASTM D 2414) of less than 115 ml/100 g; more preferably in a weight content within the range of about 23±12 wt.-%, relative to the total weight of the curable one-component composition; and - optionally, antioxidant; more preferably in a weight content within the range of about 0.3±0.2 wt.-%, relative to the total weight of the curable one-component composition.

In still other preferred embodiments, the composition according to the invention comprises the following components:
humidity-curable prepolymer; preferably silyl-modified prepolymer; more preferably in a weight content within the range of about 42±10 wt.-%, relative to the total weight of the curable one-component composition;
optionally, highly structured carbon black; preferably wherein the highly structured carbon black has an oil absorption number (OAN, ASTM D 2414) of at least 115 ml/100 g; more preferably in a weight content within the range of about 0.5±0.25 wt.-%, relative to the total weight of the curable one-component composition;
fumed silica; preferably hydrophobic fumed silica; preferably in a weight content within the range of about 17±7.0 wt.-%, relative to the total weight of the curable one-component composition;
plasticizer; preferably 1,2-cyclohexane dicarboxylic acid ester or phthalate, more preferably 1,2-cyclohexane dicarboxylic acid diisononyl ester (DINCH) or diisononylphthalate (DINP); still more preferably in a weight content within the range of about 20±10 wt.-%, relative to the total weight of the curable one-component composition;
optionally, silane compatibilizer; preferably an amino silane, more preferably a diamino-functional silane or a multifunctional aminosilane, still more preferably N-2-aminoethyl-3-aminopropyltrimethoxysilane (DAMO); yet more preferably in a weight content within the range of about 1.0±0.5 wt.-%, relative to the total weight of the curable one-component composition;
optionally, moisture scavenger; preferably vinyltrimethoxy silane (VTMO); more preferably in a weight content within the range of about 0.5±0.25 wt.-%, relative to the total weight of the curable one-component composition;
optionally, curing catalyst; preferably a tin curing catalyst; more preferably in a weight content within the range of about 0.1±0.05 wt.-%, relative to the total weight of the curable one-component composition;
optionally, filler; preferably calcium carbonate and/or carbon black, wherein the carbon black preferably has an oil absorption number (OAN, ASTM D 2414) of less than 115 ml/100 g; more preferably in a weight content within the range of about 14±5.0 wt.-%, relative to the total weight of the curable one-component composition; and
optionally, antioxidant; preferably in a weight content within the range of about 0.3±0.2 wt.-%, relative to the total weight of the curable one-component composition.

In still other preferred embodiments, the composition according to the invention comprises the following components:
humidity-curable prepolymer; preferably silyl-modified prepolymer; more preferably in a weight content within the range of about 42±10 wt.-%, relative to the total weight of the curable one-component composition;
optionally, highly structured carbon black; preferably wherein the highly structured carbon black has an oil absorption number (OAN, ASTM D 2414) of at least 115 ml/100 g; more preferably in a weight content within the range of about 17±7.0 wt.-%, relative to the total weight of the curable one-component composition;
fumed silica; preferably hydrophobic fumed silica; preferably in a weight content within the range of about 1.0±0.5 wt.-%, relative to the total weight of the curable one-component composition;
plasticizer; preferably 1,2-cyclohexane dicarboxylic acid ester or phthalate, more preferably 1,2-cyclohexane dicarboxylic acid diisononyl ester (DINCH) or diisononylphthalate (DINP); still more preferably in a weight content within the range of about 20±10 wt.-%, relative to the total weight of the curable one-component composition;
optionally, silane compatibilizer; preferably an amino silane, more preferably a diamino-functional silane or a multifunctional aminosilane, still more preferably N-2-aminoethyl-3-aminopropyltrimethoxysilane (DAMO); yet more preferably in a weight content within the range of about 1.0±0.5 wt.-%, relative to the total weight of the curable one-component composition;
optionally, moisture scavenger; preferably vinyltrimethoxy silane (VTMO); more preferably in a weight content within the range of about 0.5±0.25 wt.-%, relative to the total weight of the curable one-component composition;
optionally, curing catalyst; preferably a tin curing catalyst; more preferably in a weight content within the range of about 0.1±0.05 wt.-%, relative to the total weight of the curable one-component composition;
optionally, filler; preferably calcium carbonate and/or carbon black, wherein the carbon black preferably has an oil absorption number (OAN, ASTM D 2414) of less than 115 ml/100 g; more preferably in a weight content within the range of about 23±12 wt.-%, relative to the total weight of the curable one-component composition; and
optionally, antioxidant; more preferably in a weight content within the range of about 0.3±0.2 wt.-%, relative to the total weight of the curable one-component composition.

In preferred embodiments, the curable one-component composition according to the invention comprises components
(i) and (ii); or (i), (ii), and (v); or (i), (ii), and (vi); or (i), (ii), (v), and (vi); or (i), (ii), (v), and (vii); or (i), (ii), (vi), and (vii); or (i), (ii), (v), (vi), and (vii); or
(i) and (iii); or (i), (iii), and (v); or (i), (iii), and (vi); or (i), (iii), (v), and (vi); or (i), (iii), (v), and (vii); or (i), (iii), (vi), and (vii); or (i), (iii), (v), (vi), and (vii); or
(i), (ii), and (iii); or (i), (ii), (iii), and (v); or (i), (ii), (iii), and (vi); or (i), (ii), (iii), (v), and (vi); or (i), (ii), (iii), (v), and (vii); or (i), (ii), (iii), (vi), and (vii); or (i), (ii), (iii), (v), (vi), and (vii); or
(i), (ii), (iv), (v), and (vi).

The curable one-component composition according to the invention, in its uncured state, is preferably characterized by various properties.

In preferred embodiments, the curable one-component composition according to the invention has a Brookfield viscosity (ASTM D789, D4878)
of at least about 5,000 mPa·s, preferably at least about 10,000 mPa·s, more preferably at least about 15,000 mPa·s, still more preferably at least about 50,000 mPa·s, yet more preferably at least about 75,000 mPa·s, most preferably at least about 100,000 mPa·s; and/or
of at most about 600,000 mPa·s, preferably at most about 500,000 mPa·s, more preferably at most about 400,000 mPa·s; and/or
within the range from about 5,000 to 600,000 mPa·s, preferably from about 10,000 to 500,000 mPa·s, more preferably from about 15,000 to 400,000 mPa·s, still more preferably from about 50,000 to 600,000 mPa. s, yet more preferably from about 75,000 to 500,000 mPa·s, most preferably from about 100,000 to 400,000 mPa·s.

In preferred embodiments, the curable one-component composition according to the invention has an open time within the range of from about 5.0 to 40 minutes, wherein the open time is determined by means of a spatula in contact to the curing composition. When no material of the curing composition is transferred to the spatula anymore, this is defined as the open time. Typically, the spatula is made from stainless steel.

In preferred embodiments, the curable one-component composition according to the invention has a handling time to reach a lap shear strength of 0.5 MPa determined according to DIN 53504:201703 within the range of from about 0.5 to 8 hours.

In preferred embodiments, the curable one-component composition according to the invention has a handling time to reach a lap shear strength of 0.5 MPa determined according to DIN 53504:2017-03 of
at least 30 minutes, preferably within the range of from 0.5 to 2 hours; these embodiments are particularly preferred for applications in automotive industries; or
at least 2 hours, preferably within the range of from 4 to 8 hours ; these embodiments are particularly preferred for applications in rail or bus industries as well as for fenestration.

In preferred embodiments, the curable one-component composition according to the invention has an open time determined according to the description as described above of
at least 5 minutes, preferably within the range of from 5 to 20 minutes; these embodiments are particularly preferred for applications in automotive industries as well as for fenestration; or
at least 20 minutes, preferably within the range of from 20 to 40 minutes; these embodiments are particularly preferred for applications in rail or bus industries.

In preferred embodiments, the curable one-component composition according to the invention a curing time of at least about 3 mm/24 h, wherein the curing time is determined by applying a bead of the curable composition, cutting the bead, and measuring the thickness of the cut bead skin over time. The applied bead has a diameter typically within the ranges of from 1.0 to 5.0 cm.

Another aspect of the invention relates to a cartridge containing the curable one-component composition according to the invention as described above.

Another aspect of the invention relates to a cured composition that is obtainable by curing the curable one-component composition according to the invention as described above.

In preferred embodiments, the cured composition according to the invention has a slippage resistance within the range from about 0 to 2 mm, wherein the slippage resistance is determined by using a conventional lap shear test set up, in a vertical arrangement, with a weight applied to the lower substrate. Displacement is then measured over time.

In preferred embodiments, the cured composition according to the invention has a tensile strength determined according to EN ISO DIN 53504:2017-03 of at least about 2.0 MPa, preferably at least about 3.0 MPa, more preferably at least about 4.5 MPa.

In preferred embodiments, the cured composition according to the invention has an electrical conductivity determined according to ASTM D257-14 at 23° C. determined within the range from about 1·10⁻⁸ Ωcm to about 1·10⁻¹¹ Ωcm.

In preferred embodiments, the cured composition according to the invention has a G-modulus determined according to DIN EN 1465 of at least about 1.0 MPa, preferably within the range from about 1.0 to 3.5 MPa.

In preferred embodiments, the cured composition according to the invention a G-modulus determined according to DIN EN 1465
of at least about 1.0 MPa, preferably within the range from about 1.0 to 2.0 MPa; these embodiments are particularly preferred for applications in rail or bus industries; or
of at least about 1.5 MPa, preferably within the range from about 1.5 to 3.5 MPa; these embodiments are particularly preferred for applications in automotive industries.

In preferred embodiments, the cured composition according to the invention has an elongation determined according to DIN EN 1465 of at least about 250%.

In preferred embodiments, the cured composition according to the invention has an elongation determined according to DIN EN 1465 of
at least about 200%, preferably within the range of from about 250 to 300%; these embodiments are particularly preferred for applications in bus or automotive industries; or
at least 400%; these embodiments are particularly preferred for applications in rail industries.

Another aspect of the invention relates to the use of a curable one-component composition according to the invention as described above as a sealant and/or an adhesive.

In preferred embodiments, the use according to the invention is for fenestration.

In preferred embodiments, the use according to the invention is in the production of a vehicle selected from the group consisting of automobiles, railway vehicles, and commercial vehicles.

For applications in rail industry, the curable one-component composition according to the invention preferably provides
a high slip resistance for sealing heavy screens,
open times in the range of from about 20 to 40 minutes,
handling strength to reach 0.6 MPa within the range of from about 4 to 8 hours,
a G modulus within the range of from about 1.0 to 2.0 MPa,
elongation of greater than 400%, and
a tensile strength of greater than 4.5 MPa.

For applications in bus industry the curable one-component composition according to the invention preferably provides
a high slip resistance for sealing heavy screens,
open times in the range of from about 20 to 40 minutes,
handling strength to reach 0.6 MPa within the range of from about 4 to 8 hours,
energy impact absorption of about 3 Joule for FMVSS212 crash worthiness (front screen),
a G modulus within the range of from about 1.0 to 2.0 MPa,
elongation within the range of from about 250 to 300%, and
a tensile strength of greater than 4.5 MPa.

For applications in automotive industry, the curable one-component composition according to the invention preferably provides
a high slip resistance for sealing lighter screens,
open times in the range of from about 5 to 20 minutes,
handling strength to reach 0.5 MPa within the range of from about 0.5 to 2 hours,
energy impact absorption of about 3 Joule for FMVSS212 crash worthiness (front screen),
a G modulus within the range of from about 1.5 to 3.5 MPa,
elongation within the range of from about 250 to 300%, and
a tensile strength of greater than 4.5 MPa.

For applications in fenestration, the curable one-component composition according to the invention preferably provides
a high slip resistance for sealing lighter screens,
open times in the range of from about 5 to 20 minutes,
handling strength to reach 0.6 MPa within the range of from about 4 to 8 hours, and
electrical nonconductivity, i.e. resistivity.

Another aspect of the invention relates to a method of bonding a first substrate to a second substrate comprising the steps of
(a) contacting a surface of the first substrate and a surface of the second substrate with a curable one-component composition according to the invention as described above; and
(b) allowing the curable one-component composition to cure.

Preferably, the first substrate and/or the second substrate is glass.

Another aspect of the invention relates to a method of sealing a contact area of a first substrate and a second substrate comprising the steps of
(a) contacting a surface of the first substrate and a surface of the second substrate with a curable one-component composition according to the invention as described above; and
(b) allowing the curable one-component composition to cure.

Preferably, the first substrate and/or the second substrate is glass.

The following examples further illustrate the invention but are not to be construed as limiting its scope:

### EXAMPLE 1

### Influence of Highly Structured Carbon Black

Three samples with and without highly structured carbon black were tested. The samples contained the following ingredients:

| | comparative | | inventive |
|---|---|---|---|
| [wt.-%] | 1-1 | 1-2 | 1-3 |
| silyl-modified prepolymer | 42.7 | 42.7 | 42.7 |
| standard carbon black grade 1 (Monarch | 17.0 | — | — |
| 900) OAN¹ 64 ml/100 g | | | |
| standard carbon black grade 2 (Monarch | — | 17.0 | — |
| 570) OAN 114 ml/100 g | | | |
| highly structured carbon black OAN 150 | — | — | 17.0 |
| ml/100 g | | | |
| fumed silica | 1.0 | 1.0 | 1.0 |
| 1,2-cyclohexane dicarboxylic acid | 19.5 | 19.5 | 19.5 |
| diisononyl ester (DINCH) | | | |
| vinyltrimethoxy silane (VTMO) | 0.5 | 0.5 | 0.5 |
| N-2-aminoethyl-3- | 1.0 | 1.0 | 1.0 |
| aminopropyltrimethoxysilane (DAMO) | | | |
| tin catalyst | 0.1 | 0.1 | 0.1 |
| calcium carbonate | 13.9 | 13.9 | 13.9 |
| antioxidant | 0.3 | 0.3 | 0.3 |

¹oil absorption number

Thus, inventive sample 1-3 differed from comparative samples 1-1 and 1-2 only in the content of highly structured carbon black. The amount of highly structured carbon black was substituted in comparative samples 1-1 and 1-2 with the corresponding amount of standard carbon black in order to allow for meaningful conclusions so that differences in performance of the samples are directly attributable to the presence and absence of highly structured carbon black.

A peel adhesion test was performed in accordance with DIN EN 14457 with regard to improved adhesion after storage under various storage conditions. The results of the measurements are compiled in the following table:

| | | Storage Conditions | | | |
|---|---|---|---|---|---|
| Substrate | Adhesive | 7 d rt | +7 d H₂O | 7 d 90° C. | +7 d Cataplasma |
| Aluminum | 1-1 | 100% CF | 100% CF | 100% CF | 100% AF |
| Electrogalvanized steel | | 100% CF | 100% AF | 100% CF | 100% AF |
| Hot dip galvanized steel | | 100% CF | 100% AF | 100% CF | 95% CF |
| Epoxy coated | | 100% CF | 100% AF | 100% CF | 100% CF |
| Polyester coated | | 100% AF | 100% AF | 100% AF | 100% AF |
| Floatglass | | 100% CF | 100% AF | 100% CF | 100% CF |
| Aluminum | 1-3 | 100% CF | 100% CF | 100% CF | 100% CF |
| Electrogalvanized steel | | 100% CF | 90% CF | 100% CF | 80% CF |
| Hot dip galvanized steel | | 100% CF | 100% CF | 100% CF | 100% CF |
| Epoxy coated | | 100% CF | 100% CF | 100% CF | 100% CF |
| Polyester coated | | 100% AF | 100% AF | 100% AF | 100% AF |
| Floatglass | | 100% CF | 100% AF | 100% CF | 100% CF |

AF adhesive failure;
CF cohesive failure;
rt room temperature

Cohesive failure (CF) indicates advantages, whereas adhesive failure (AF) is not desirable. As demonstrated by the above comparative data, the inventive sample 1-3 has significant advantages compared to comparative sample 1-1 after storage under conditions “+7d H₂O” and “+7d cataplasma”. This advantage is attributable to the highly structured carbon black.

Post cure performance was investigated in terms of tensile strength and elongation. Tensile strength and elongation were measured in accordance with DIN EN ISO 527 with regard to improved stability after storage at 80° C. for 1000 hours compared to the respective values before storage. The results of the measurements are compiled in the following table:

| | |
|---|---|
| Tensile strength | Elongation |

| | [MPa] | % difference | [%] | % difference |
|---|---|---|---|---|
| 1-1 | 2.5 | −71 | 120 | −78 |
| 1-2 | 3.5 | −56 | 180 | −63 |
| 1-3 | 6 | −5 | 342 | −17 |

As demonstrated by the above comparative data, the inventive sample 1-3 has significant advantages compared to comparative samples 1-1 and 1-2 with respect to tensile strength and elongation after storage compared to before storage. This advantage is attributable to the highly structured carbon black.

Analogous results are obtained when the plasticizer 1,2-cyclohexane dicarboxylic acid diisononyl ester (DINCH) is replaced by other plasticizers, in particular by a polyol plasticizer or a SAN-grafted polyol plasticizer.

### EXAMPLE 2

### Influence of Polycarbonate Diol

Four samples with and without polycarbonate diol were tested. The samples contained the following ingredients:

| | inventive | | comparative | |
|---|---|---|---|---|
| [wt.-%] | 2-1 | 2-2 | 2-3 | 2-4 |
| silyl-modified prepolymer | 37.5 | 31.5 | 40.0 | 31.5 |
| standard carbon black (Raven 900) OAN¹ | — | — | 0.5 | 0.5 |
| 108 ml/100 g | | | | |
| highly structured carbon black OAN ≥120 | 0.5 | 0.5 | — | — |
| ml/100 g | | | | |
| 1,6 hexanediol based polycarbonate diol | 23.3 | — | 23.3 | — |
| polypropylene glycol (PPG) | 2.5 | 2.5 | 2.5 | 2.5 |
| N-2-aminoethyl-3- | 1.0 | 1.0 | 1.0 | 1.0 |
| aminopropyltrimethoxysilane (DAMO) | | | | |
| vinyltrimethoxy silane (VTMO) | 2.0 | 2.0 | 2.0 | 2.0 |
| calcium carbonate | 17.0 | 17.0 | 17.0 | 17.0 |
| calcium carbonate nano | 15.2 | 43.5 | 12.7 | 43.5 |
| triethyl phosphate | 2.0 | 2.0 | 2.0 | 2.0 |

¹oil absorption number

Thus, samples 2-1 and 2-3 differed from samples 2-2 and 2-4 only in the content of polycarbonate diol, respectively. The amount of polycarbonate diol was substituted in samples 2-2 and 2-4 with the corresponding amount of silyl-modified prepolymer and/or calcium carbonate in order to allow for meaningful conclusions so that differences in performance of the samples are directly attributable to the presence and absence of polycarbonate diol.

Short-time strength and improved cycle time performance was investigated in terms of lap shear strength. Lap shear strength was measured in accordance with DIN EN 1465 after curing for 200 seconds and 15 minutes, respectively. The results of the measurements are compiled in the following table:

| | LS 200 s | LS 15 min |
|---|---|---|
| | [MPa] | [MPa] |
| 2-1 | 0.9 | 0.12 |
| 2-2 | 0.05 | 0.06 |
| 2-3 | 0.1 | 0.15 |
| 2-4 | 0 | 0.02 |

As demonstrated by the above comparative data, the samples 2-1 and 2-3 have significant advantages compared to samples 2-2 and 2-4 with respect to short-time strength and cycle time. This advantage is attributable to the polycarbonate diol.

### EXAMPLE 3

### Influence of Fumed Silica

Two samples with and without fumed silica were tested. The samples contained the following ingredients:

| [wt.-%] | 3-1 | 3-2 | 3-3 |
|---|---|---|---|
| silyl-modified prepolymer | 42.7 | 42.7 | 42.7 |
| carbon black | 0.5 | 17.0 | 17.0 |
| hydrophobic fumed silica, treated with PDMS | 16.5 | — | — |
| fumed silica | 1.0 | 1.0 | 1.0 |
| diisononylphthalate (DINP) | 19.5 | 19.5 | — |
| 1,2-cyclohexane dicarboxylic acid diisononyl | — | — | 19.5 |
| ester (DINCH) | | | |
| vinyltrimethoxy silane (VTMO) | 0.5 | 0.5 | 0.5 |
| tin catalyst | 0.1 | 0.1 | 0.1 |
| calcium carbonate | 13.9 | 13.9 | 13.9 |
| N-2-aminoethyl-3-aminopropyltrimethoxysilane | 1.0 | 1.0 | 1.0 |
| (DAMO) | | | |
| antioxidant | 0.3 | 0.3 | — |

Thus, sample 3-1 differed from samples 3-2 and 3-3 only in the content/type of fumed silica. The amount of fumed silica was substituted in samples 3-2 and 3-3 with the corresponding amount of standard carbon clack in order to allow for meaningful conclusions so that differences in performance of the samples are directly attributable to the presence and absence of fumed silica.

A peel adhesion test was performed in accordance with DIN EN 14457 with regard to improved adhesion after storage under various storage conditions. The results of the measurements are compiled in the following table:

| | | Storage Conditions | | | |
|---|---|---|---|---|---|
| Substrate | Adhesive | 7 d rt | +7 d H₂O | 7 d 90° C. | +7 d Catasplama |
| Aluminum | 3-3 | 100% CF | 100% CF | 100% CF | 100% CF |
| Electrogalvanized steel | | 100% CF | 100% AF | 100% CF | 90% CF |
| Hot dip galvanized steel | | 100% CF | 100% AF | 100% CF | 100% AF |
| Epoxy coated | | 100% CF | 100% AF | 100% CF | 100% CF |
| Polyester coated | | 100% AF | 100% AF | 100% AF | 100% CF |
| Floatglass | | 100% CF | 100% AF | 100% CF | 100% CF |
| Aluminum | 3-2 | 100% CF | 100% CF | 100% CF | 100% AF |
| Electrogalvanized steel | | 100% CF | 100% AF | 100% CF | 100% AF |
| Hot dip galvanized steel | | 100% CF | 100% AF | 100% CF | 95% |
| Epoxy coated | | 100% CF | 100% AF | 100% CF | 100% CF |
| Polyester coated | | 100% AF | 100% AF | 100% AF | 100% AF |
| Floatglass | | 100% CF | 100% AF | 100% CF | 100% CF |
| Aluminum | 3-1 | 100% CF | 100% CF | 100% CF | 100% CF |
| Electrogalvanized steel | | 100% CF | 90% CF | 80% CF | 100% CF |
| Hot dip galvanized steel | | 100% CF | 100% AF | 100% CF | 30% CF |
| Epoxy coated | | 100% CF | 100% CF | 100% CF | 100% CF |
| Polyester coated | | 100% CF | 100% AF | 100% CF | 100% CF |
| Floatglass | | 100% CF | 100% AF | 100% CF | 100% CF |

AF adhesive failure;
CF cohesive failure;
rt room temperature

Cohesive failure (CF) indicates advantages, whereas adhesive failure (AF) is not desirable. As demonstrated by the above comparative data, the sample 3-1 has significant advantages compared to samples 3-2 and 3-3. This advantage is attributable to the hydrophobic fumed silica.

1. A curable one-component composition comprising
(i) humidity-curable prepolymer, preferably silyl-modified prepolymer;
(ii) optionally, highly structured carbon black; preferably carbon black having an oil absorption number (OAN, ASTM D 2414) of at least 115 ml/100 g;
(iii) optionally, fumed silica, preferably hydrophobic fumed silica;
(iv) optionally, polycarbonate, preferably polycarbonate diol;
(v) optionally, plasticizer; preferably selected from the group consisting of polyol, SAN-grafted polyol, 1,2-cyclohexane dicarboxylic acid esters, phthalates, and mixtures thereof; more preferably selected from the group consisting of polyol, SAN-grafted polyol, 1,2-cyclohexane dicarboxylic acid esters, and mixtures thereof;
(vi) optionally, silane compatibilizer; and
(vii) optionally, curing catalyst;
with the proviso that the composition comprises (ii), or (iii), or both (ii) and (iii).

2. (canceled)

3. The curable one-component composition according to claim 1, wherein the humidity-curable prepolymer comprises or essentially consist of a silyl-modified prepolymer.

4-12. (canceled)

13. The curable one-component composition according to claim 1, wherein the humidity-curable prepolymer comprises a polymeric backbone selected from the group consisting of polyethers, copolyethers, polyurethanes, copolyurethanes, polyesters, copolyesters, polyamides, copolyamids, polyolefins, copolyolefins, polystyrenes, copolystyrenes, polyacrylates, copolyacrylates, and mixtures thereof; preferably polyethers or copolyethers.

14-17. (canceled)

18. The curable one-component composition according to claim 1, wherein the weight content of the humidity-curable prepolymer is at least about 10 wt.-%, preferably at least about 12 wt.-%, more preferably at least about 15 wt.-%, still more preferably at least about 18 wt.-%, yet more preferably at least about 22 wt.-%, even more preferably at least about 26 wt.-%, most preferably at least about 30 wt.-%, and in particular at least about 35 wt.-%, in each case relative to the total weight of the curable one-component composition.

19. The curable one-component composition according to claim 1, wherein the weight content of the humidity-curable prepolymer is at most about 90 wt.-%, preferably at most about 85 wt.-%, more preferably at most about 80 wt.-%, still more preferably at most about 75 wt.-%, yet more preferably at most about 70 wt.-%, even more preferably at most about 65 wt.-%, most preferably at most about 60 wt.-%, and in particular at most about 55 wt.-%; more preferably less than 50 wt.-%; still more preferably at most 45 wt.-%; in each case relative to the total weight of the curable one-component composition.

20. (canceled)

21. The curable one-component composition according to claim 19, which comprises highly structured carbon black; preferably wherein the highly structured carbon black comprises or essentially consist of furnace black and/or has a iodine number (ASTM D1510) of at least 95 g/kg and an oil absorption number (OAN, ASTM D 2414) of at least 110 ml/100 g; preferably at least 115 ml/100 g.

22. The curable one-component composition according to claim 19, wherein the highly structured carbon black is typified according to ASTM D 1765 as super abrasion resistant furnace black (SAF-HS), intermediate super abrasion resistant furnace black (ISAF-HS), high abrasion resistant furnace black (HAF-HS), general purpose furnace black (GPF-HS), or semi reinforcing furnace black (SRF-HS).

23. The curable one-component composition according to claim 19, wherein the highly structured carbon black is classified according to ASTM D 1765 in a group selected from N110, N115, N120, N121, N125, N134, N135, N219, N220, N231, N234, N293, N299, N326, N330, N335, N339, N343, N347, N351, N356, N358, N375, N539, N550, N582, N630, N642, N650, N660, N683, N754, N762, N765, N772, N774, and N787; preferably N115, N121, N234, N339, N375, N539, N550, N650, and N765.

24-50. (canceled)

51. The curable one-component composition according to claim 1, wherein the weight content of the highly structured carbon black is at least about 3.0 wt.-%, preferably at least about 4.0 wt.-%, more preferably at least about 5.0 wt.-%, still more preferably at least about 6.0 wt.-%, yet more preferably at least about 7.0 wt.-%, even more preferably at least about 8.0 wt.-%, most preferably at least about 9.0 wt.-%, and in particular at least about 10 wt.-%; in each case relative to the total weight of the curable one-component composition.

52. The curable one-component composition according to claim 1, wherein the weight content of the highly structured carbon black is at most about 27 wt.-%, preferably at most about 26 wt.-%, more preferably at most about 25 wt.-%, still more preferably at most about 24 wt.-%, yet more preferably at most about 23 wt.-%, even more preferably at most about 22 wt.-%, most preferably at most about 21 wt.-%, and in particular at most about 20 wt.-%; preferably less than 20 wt.-%; more preferably at most 19 wt.-%, still more preferably at most 18 wt.-%; in each case relative to the total weight of the curable one-component composition.

53. (canceled)

54. The curable one-component composition according claim 1, which comprises polycarbonate;
preferably wherein the polycarbonate comprises or essentially consist of a polycarbonate diol, preferably having general formula (III)
HO—R1—[O—C(═O)—O—R2]ₙ—OH (III);
wherein R1 and R2 are independently of one another selected from the group consisting of -C₁₋₁₂-alkylene-, -C₄₋₁₀-cycloalkylene-, -C₁₋₁₂-alkylene-C₄₋₁₀-cycloalkylene-C₁₋₁₂-alkylene-, -C₆₋₁₀-aryl-, -C₁₋₁₂-alkylene-C₆₋₁₀-aryl-C₁₋₁₂-alkylene-, -C₆₋₁₀-aryl-C₁₋₁₂-alkylene-C₆₋₁₀-aryl-, -[C₁₋₆-alkylene-O]ₘ-C₁₋₆-alkylene-, -[C₁₋₆alkylene-O]ₘ-C₆₋₁₀-aryl-, -C(═O)—O—C₁₋₁₂-alkylene-, -C(═O)—O—C₁₋₆-alkylene-O—C₁₋₆alkylene-, —C(═O)—O—C₆₋₁₀-aryl-, —C(═O)-O—C₁₋₆-alkylene-C₆₋₁₀-aryl-, —C(═O)—O—C₁₋₆alkylene-O—C₆₋₁₀-aryl-; wherein m is an integer within the range of from 1 to 10; and wherein n is an integer within the range of from 1 to 25, preferably 1, 2, 3, or 4.

55-60. (canceled)

61. The curable one-component composition according to claim 54, wherein the weight content of the polycarbonate, preferably the polycarbonate diol, is at least about 0.4 wt.-%, preferably at least about 0.6 wt.-%, more preferably at least about 0.8 wt.-%, still more preferably at least about 1.0 wt.-%, yet more preferably at least about 1.5 wt.-%, even more preferably at least about 2.0 wt.-%, most preferably at least about 3.5 wt.-%, and in particular at least about 5.0 wt.-%; or at least about 6.0 wt.-%, preferably at least about 8.0 wt.-%, more preferably at least about 10 wt.-%, still more preferably at least about 12 wt.-%, yet more preferably at least about 14 wt.-%, even more preferably at least about 16 wt.-%, most preferably at least about 18 wt.-%, and in particular at least about 20 wt.-%; in each case relative to the total weight of the curable one-component composition.

62. The curable one-component composition according claim 54, wherein the weight content of the polycarbonate, preferably the polycarbonate diol, is at most about 50 wt.-%, preferably at most about 45 wt.-%, more preferably at most about 40 wt.-%, still more preferably at most about 38 wt.-%, yet more preferably at most about 36 wt.-%, even more preferably at most about 34 wt.-%, most preferably at most about 32 wt.-%, and in particular at most about 31 wt.-%; or at most about 30 wt.-%, preferably at most about 27 wt.-%, more preferably at most about 24 wt.-%, still more preferably at most about 22 wt.-%, yet more preferably at most about 18 wt.-%, even more preferably at most about 16 wt.-%, most preferably at most about 12 wt.-%, and in particular at most about 10 wt.-%; in each case relative to the total weight of the curable one-component composition.

63-76. (canceled)

77. The curable one-component composition according to claim 1, wherein the weight content of the fumed silica, preferably hydrophobic fumed silica, is at least about 0.1 wt.-%, preferably at least about 0.2 wt.-%, more preferably at least about 0.3 wt.-%, still more preferably at least about 0.4 wt.-%, yet more preferably at least about 0.5 wt.-%, even more preferably at least about 0.6 wt.-%, most preferably at least about 0.8 wt.-%, and in particular at least about 1.0 wt.-%; or at least about 3.0 wt.-%, preferably at least about 4.0 wt.-%, more preferably at least about 5.0 wt.-%, still more preferably at least about 6.0 wt.-%, yet more preferably at least about 7.0 wt.-%, even more preferably at least about 8.0 wt.-%, most preferably at least about 9.0 wt.-%, and in particular at least about 10 wt.-%; in each case relative to the total weight of the curable one-component composition.

78. The curable one-component composition according to claim 1, wherein the weight content of the fumed silica, preferably hydrophobic fumed silica, is at most about 44 wt.-%, preferably at most about 42 wt.-%, more preferably at most about 40 wt.-%, still more preferably at most about 38 wt.-%, yet more preferably at most about 36 wt.-%, even more preferably at most about 34 wt.-%, most preferably at most about 32 wt.-%, and in particular at most about 30 wt.-%; or at most about 27 wt.-%, preferably at most about 26 wt.-%, more preferably at most about 25 wt.-%, still more preferably at most about 24 wt.-%, yet more preferably at most about 23 wt.-%, even more preferably at most about 22 wt.-%, most preferably at most about 21 wt.-%, and in particular at most about 20 wt.-%; in each case relative to the total weight of the curable one-component composition.

79-82. (canceled)

83. The curable one-component composition according to claim 77, which comprises a plasticizer; preferably wherein the plasticizer comprises or essentially consist of a copolymer polyol, preferably a copolymer of a polymeric material grafted onto a main polyol chain, more preferably a SAN (styrene/acrylonitrile) or an AN (acrylonitrile) grafted onto a polyether polyol or onto a polyester polyol.

84-91. (canceled)

92. The curable one-component composition according to claim 83, wherein the weight content of the plasticizer is at least about 2.0 wt.-%, preferably at least about 3.0 wt.-%, more preferably at least about 4.0 wt.-%, still more preferably at least about 5.0 wt.-%, yet more preferably at least about 6.0 wt.-%, even more preferably at least about 7.0 wt.-%, most preferably at least about 8.0 wt.-%, and in particular at least about 10 wt.-%; in each case relative to the total weight of the curable one-component composition.

93. The curable one-component composition according to claim 83, wherein the weight content of the plasticizer is at most about 50 wt.-%, preferably at most about 45 wt.-%, more preferably at most about 40 wt.-%, still more preferably at most about 37 wt.-%, yet more preferably at most about 34 wt.-%, even more preferably at most about 31 wt.-%, most preferably at most about 28 wt.-%, and in particular at most about 25 wt.-%; in each case relative to the total weight of the curable one-component composition.

94-123. (canceled)

124. A cured composition obtainable by curing the curable one-component composition according to claim 1.

125. The cured composition according to claim 124, which has
a slippage resistance determined according to the description within the range from about 0 to 2 mm; and/or
a tensile strength determined according to EN ISO DIN 53504:2017-03 of at least about 2.0 MPa, preferably at least about 3.0 MPa, more preferably at least about 4.5 MPa; and/or
a G-modulus determined according to DIN EN 1465 of at least about 1.0 MPa, preferably within the range from about 1.0 to 3.5 MPa; and/or
an elongation determined according to DIN EN 1465 of at least about 250%; and/or
an electrical conductivity determined according to ASTM D257-14 within the range from about 1·10⁻⁸ Ωcm to about 1·10⁻¹¹ Ωcm.

126-134. (canceled)
